(19) United States
(12) Patent Application Publication
(10) Pub. No.: US 2025/0379993 A1
(43) Pub. Date: Dec. 11, 2025

(54) VIDEO DECODING METHOD, VIDEO ENCODING METHOD, AND RELATED DEVICE

(71) Applicant: Tencent Technology (Shenzhen) Company Limited, Shenzhen (CN)

(72) Inventor: Liqiang WANG, Shenzhen (CN)

(21) Appl. No.: 19/309,453

(22) Filed: Aug. 25, 2025

Related U.S. Application Data
(63) Continuation of application No. PCT/CN2024/091163, filed on May 6, 2024.

(30) Foreign Application Priority Data
Jun. 14, 2023 (CN) 202310709242.7

(51) Int. Cl. H04N 19/44; H04N 19/105; H04N 19/13; H04N 19/18; H04N 19/91

(52) U.S. Cl. CPC H04N 19/44; H04N 19/105; H04N 19/13; H04N 19/18; H04N 19/91

(57) ABSTRACT

This application provide a video decoding method performed by a computer device. The method includes: determining a current coding unit in a video bitstream, and an adjacent coding unit of the current coding unit; determining transform information of the current coding unit according to encoding information of the adjacent coding unit; and decoding the current coding unit based on the determined transform information of the current coding unit. The embodiments of this application can reduce bit rate consumption in a video encoding and decoding process.

### CROSS-REFERENCE TO RELATED APPLICATIONS

This application is a continuation application of PCT Patent Application No. PCT/CN2024/091163, entitled “VIDEO DECODING METHOD, VIDEO ENCODING METHOD, AND RELATED DEVICE” filed on May 6, 2024, which claims priority to Chinese Patent Application No. 202310709242.7, entitled “VIDEO DECODING METHOD, VIDEO ENCODING METHOD, AND RELATED DEVICE” filed with the China National Intellectual Property Administration on Jun. 14, 2023, both of which are incorporated herein by reference in their entirety.

### FIELD OF THE TECHNOLOGY

This application relates to the field of audio and video technologies, and specifically, to a video decoding method, a video encoding method, a video decoding apparatus, a video encoding apparatus, a computer device, a computer-readable storage medium, and a computer program product.

### BACKGROUND OF THE DISCLOSURE

In an existing video encoding technology, a video frame may be divided into a series of coding units, and video compression is implemented using video encoding methods such as prediction, transform, and entropy coding. The coding unit may be transformed using various transform methods including transform partitioning modes (such as a residual quad tree (RQT) mode and a position based transform (PBT) mode) and transform combinations (such as a discrete cosine transform (DCT) kernel and a discrete sine transform (DST) kernel). Different transform information is obtained by different transform methods, and when transforming a coding unit, an encoder side also needs to encode the transform information, resulting in high bit rate consumption.

### SUMMARY

Embodiments of this application provide a video decoding method, a video encoding method, and a related device, to reduce bit rate consumption in a video encoding and decoding process.

According to an aspect, an embodiment of this application provides a video decoding method. The method includes:
determining a current coding unit in a video bitstream, and an adjacent coding unit of the current coding unit;
determining transform information of the current coding unit according to encoding information of the adjacent coding unit; and
decoding the current coding unit based on the determined transform information of the current coding unit.

According to an aspect, an embodiment of this application provides a computer device. The computer device includes:
a processor; and
a computer-readable storage medium, having a computer program stored therein, the computer program, when executed by the processor of the computer device, causing the computer device to perform the foregoing video decoding method.

According to an aspect, an embodiment of this application provides a non-transitory computer-readable storage medium storing a video bitstream that is generated by the foregoing video decoding method.

In the embodiments of this application, in an encoding and decoding process of a current coding unit in a video, transform information of the current coding unit may be determined based on encoding information of an adjacent coding unit of the current coding unit, and the current coding unit is encoded and decoded based on the determined transform information of the current coding unit. In this way, the transform information of the current coding unit does not need to be encoded. Therefore, encoding costs consumed for encoding the transform information of the current coding unit can be reduced, thereby reducing bit rate consumption in the entire encoding and decoding process, and further improving decoding efficiency.

### BRIEF DESCRIPTION OF THE DRAWINGS

FIG. 1 is a basic working flowchart of a video encoder according to an exemplary embodiment of this application.

FIG. 2 is a schematic diagram of a residual quad tree partition mode according to an exemplary embodiment of this application.

FIG. 3 is a schematic diagram of a position based sub-block transform according to an exemplary embodiment of this application.

FIG. 4A is a schematic diagram of a sub-block transform according to an exemplary embodiment of this application.

FIG. 4B is a schematic diagram of a transform combination corresponding to each residual position mode in 12 residual position modes according to an exemplary embodiment of this application.

FIG. 5 is an architectural diagram of a video encoding and decoding system according to an exemplary embodiment of this application.

FIG. 6 is a schematic flowchart of a video decoding method according to an exemplary embodiment of this application.

FIG. 7A is a schematic diagram of a transform block adjacent to a current coding unit according to an exemplary embodiment of this application.

FIG. 7B is a schematic diagram of a transform block adjacent to a current coding unit according to another exemplary embodiment of this application.

FIG. 8 is a schematic diagram of a position relationship between a first adjacent coding unit and a current coding unit and a position relationship between a second adjacent coding unit and the current coding unit according to an exemplary embodiment of this application.

FIG. 9 is a schematic flowchart of a video encoding method according to an exemplary embodiment of this application.

FIG. 10 is a schematic structural diagram of a video decoding apparatus according to an exemplary embodiment of this application.

FIG. 11 is a schematic structural diagram of a video encoding apparatus according to another exemplary embodiment of this application.

FIG. 12 is a schematic structural diagram of a computer device according to another exemplary embodiment of this application.

### DESCRIPTION OF EMBODIMENTS

The following describes technical terms involved in this application:

### 1. Video Encoding

A video may include one or more video frames, and each video frame includes some video signals of the video. Video signal obtaining modes may be divided into camera shooting or computer generation. Because different obtaining modes correspond to different statistical characteristics, video compression and encoding modes may also be different. In mainstream video encoding technologies, by using high efficiency video coding (HEVC/H.265), versatile video coding (VVC/H.266), and an audio video coding standard (AVS) as an example, a hybrid encoding framework is used, and the hybrid encoding framework allows a series of operations and processing to be performed on the video as follows:
(1) Block partition structure: According to a size of a video frame, the video frame may be divided into several non-overlapping processing units, and each processing unit performs a similar compression operation. The processing unit is referred to as a coding tree unit (CTU) or a largest coding unit (LCU). The CTU may be further divided more finely, to obtain one or more basic coding units, which are referred to as coding units (CUs). The CU is a most basic element in an encoding process, and subsequent embodiments of this application describe various encoding and decoding processing procedures that may be used for each CU.
(2) Prediction encoding: Prediction modes such as intra prediction and inter prediction are included. An original video signal included in the coding unit in the video frame is predicted by a reconstructed video signal in a selected coding unit to obtain a residual. An encoder side needs to select an appropriate prediction mode from a plurality of possible prediction modes for a current coding unit to perform coding, and notifies a decoder side of the selected prediction mode. The current coding unit may be a coding unit being encoded, and the prediction modes may include:
a. Intra (picture) prediction: A reconstructed video signal used for prediction comes from a region that has been encoded and reconstructed in the same video frame. In other words, the current coding unit and a prediction reference coding unit referenced by the current coding unit are located in the same video frame. A basic idea of the intra prediction is to remove space redundancy by using a correlation between adjacent pixels in the same video frame. In the video encoding, the adjacent pixels refer to reconstructed pixels of encoded coding units surrounding the current coding unit in the same video frame.
b. Inter (picture) prediction: A reconstructed video signal used for prediction comes from another video frame that has been encoded and that is different from a current frame. In other words, the current coding unit and a prediction reference coding unit referenced by the current coding unit are located in different video frames, and the current frame refers to a video frame in which the current coding unit is located.
3) Transform & Quantization: After transform operations such as discrete Fourier transform (DFT), discrete cosine transform (DCT), and discrete sine transform (DST), the residual can be converted into transform domain. The residual in transform domain is referred to as a transform coefficient. A lossy quantization operation is further performed on the residual in transform domain, to lose some information, so that a quantized signal is beneficial to compression and expression.

In some video encoding standards, there may be more than one transform methods for selection. Therefore, the encoder side also needs to select one of the transform methods for the current coding unit, and inform the decoder side. Precision of quantization is usually determined by a quantization parameter (QP). When a value of the QP is large, transform coefficients in a large value range are to be quantized into the same output. Therefore, this usually results in greater distortion and a lower bit rate. Conversely, when the value of the QP is small, transform coefficients in a small value range are to be quantized into the same output. Therefore, this usually results in smaller distortion and a higher bit rate.
4) Entropy coding or statistical coding: Statistical coding is performed on a quantized transform domain signal according to a frequency at which each value appears, and finally, a binary (0 or 1) video bitstream is outputted. In addition, the coding generates other information, such as a selected prediction mode and a motion vector. Entropy coding also needs to be performed on the other information to reduce a bit rate. The statistical coding is a lossless coding mode which can effectively reduce a bit rate required for expressing the same signal. A common statistical coding mode is variable length coding (VLC) or content adaptive binary arithmetic coding (CABAC).
5) Loop filtering: For an encoded coding unit, a decoded image corresponding to the coding unit can be reconstructed through inverse quantization, inverse transform, and prediction compensation operations (the reverse operations of 2) to 4) above). Compared with the original image, a reconstructed decoded image has some information different from the original image due to the impact of quantization, resulting in distortion. Therefore, a filter can be used to perform a filtering operation on the reconstructed decoded image to effectively reduce a degree of distortion generated by quantization. The filter may be, for example, a deblocking filter, sample adaptive offset (SAO), or an adaptive loop filter (ALF). Because reconstructed decoded images obtained by filtering are used as prediction reference coding units for other coding units that need to be encoded subsequently and applied to a prediction process of the other coding units, the foregoing filtering operation is also referred to as loop filtering, that is a filtering operation within a coding loop.

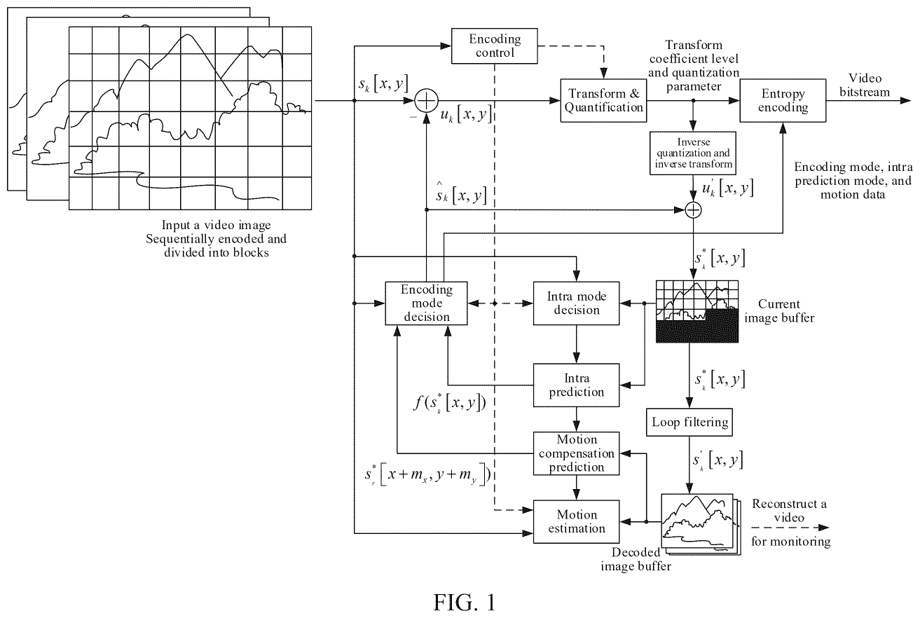

Based on the related descriptions of operation 1) to operation 5), an embodiment of this application provides a basic working flowchart of a video encoder. FIG. 1 is a basic working flowchart of a video encoder according to an exemplary embodiment of this application. FIG. 1 uses an example in which a current coding unit is a k^{th} coding unit (sₖ[x, y] shown in FIG. 1) in a current frame (a current image) for description, k being a positive integer, and k being less than or equal to a total quantity of coding units included in the current frame. sₖ[x, y] represents a pixel point (briefly referred to as a pixel) whose coordinates are [x, y] in the k^{th} coding unit, x represents a horizontal coordinate of the pixel, and y represents a vertical coordinate of the pixel. After processing such as motion compensation or intra prediction is performed on sₖ[x, y], a prediction signal ŝₖ[x, y] is obtained, and the prediction signal ŝₖ[x, y] is subtracted from the original signal sₖ[x, y] to obtain a residual uₖ[x, y]. Then, transform and quantization are performed on the residual uₖ[x, y]. Data outputted through quantization processing has two different destinations, namely, A and B:
A: The data outputted through quantization may be sent to an entropy encoder for entropy encoding, to obtain an encoded video bitstream, and the video bitstream is outputted to a buffer for storage, waiting to be transmitted.
B: Inverse quantization and inverse transform processing may be performed on the data outputted through quantization to obtain an inversely transformed residual

$${u}_{k}^{′} [ x , y ] .$$

The inversely transformed residual

$${u}_{k}^{′} [ x , y ]$$

is added to the prediction signal ŝₖ[x, y] to obtain a new prediction signal

$${s}_{k}^{*} [ x , y ] ,$$

and the new prediction signal

$${s}_{k}^{*} [ x , y ]$$

is sent to a buffer of the current image for storage. Then, intra prediction processing is performed on the new prediction signal

$${s}_{k}^{*} [ x , y ] ,$$

to obtain

$$f ( {s}_{k}^{*} [ x , y ] ) .$$

Loop filtering processing is performed on the new prediction signal

$${s}_{k}^{*} [ x , y ]$$

to obtain a reconstructed signal

$${s}_{k}^{′} [ x , y ] ,$$

and the reconstructed signal

$${s}_{k}^{′} [ x , y ]$$

is sent to a decoding image buffer for storage, to generate a reconstructed video. Motion compensation prediction processing is performed on the reconstructed signal

$${s}_{k}^{′} [ x , y ]$$

to obtain

$${s}_{r}^{*} [ x + {m}_{x} , y + {m}_{y} ] , where {s}_{r}^{*} [ x + {m}_{x} , y + {m}_{y} ]$$

may represent the prediction reference coding unit referenced by the current coding unit, and mₓ and m_{y} respectively represent a horizontal component and a vertical component of a motion vector of the prediction reference coding unit referenced by the current coding unit.

Because the prediction methods (for example, intra prediction and inter prediction) used in a prediction encoding process have a large error, the residual needs to be transmitted to compensate for a prediction video frame (that is, an image), thereby improving quality of a reconstructed video frame (that is, a decoded image). Therefore, residual processing is an important processing process in the hybrid encoding framework.

As shown in FIG. 1, in the hybrid encoding framework, the residual is a difference between the original signal (that is, an original video frame) and the prediction signal (that is, the prediction video frame):

$${u}_{k} [ x , y ] = {S}_{k} [ x , y ] - {\hat{S}}_{k} [ x , y ]$$

In the HEVC, VVC, and AVS3 video encoding standards, processing on the residual includes the following two processing modes (1) and (2):

### (1) Transform and Quantization:

By utilizing a residual correlation, transform processing is performed on residuals to concentrate energy in fewer low-frequency transform coefficients. In other words, after transform processing is performed on residuals of most coding units, transform coefficients corresponding to the residuals of the most coding units are small. The residual correlation means that there is a correlation between residuals of coding units. For example, if a residual of a coding unit refers to a residual of an adjacent coding unit, there is a correlation between the residual of the coding unit and the residual of the adjacent coding unit referenced by the residual of the coding unit. After subsequent quantization processing, a smaller transform coefficient becomes zero, greatly reducing encoding residual costs. Using the conventional DCT as an example, a transform is as follows. A two-dimensional discrete transform is implemented by using two separate one-dimensional discrete transforms (a horizontal transform and a vertical transform).

$${Co}_{k} = {CU}_{k} {C}^{T}$$

Coₖ represents a transform coefficient obtained after a residual transform of a current coding unit, Uₖ represents a residual, and C represents a transform kernel of a vertical transform; and C^{T} represents a transform kernel of a horizontal transform.

Because of diversity of residual distribution, a single DCT cannot adapt to all residual characteristics. Therefore, transform kernels such as DST7 and DCT8 are introduced into a transform process. In this way, a transform combination can be introduced during a residual transform, to resolve the problem that the single DCT cannot adapt to all the residual characteristics. The transform combination may refer to a combination of the transform kernel of the horizontal transform and the transform kernel of the vertical transform. The horizontal transform and the vertical transform may use the same transform kernel or different transform kernels. The transform kernel includes but is not limited to: DCT2, DCT8, DST7, and the like. DCT2 and DCT8 refer to different DCT transform modes, and DST7 refers to a transform mode of DST.

Using an adaptive multi-kernel transform (AMT) technology as an example, transform combinations that may be selected for a transform block (that is, a residual block that needs to be transformed) are as follows: (DCT2, DCT2), (DCT8, DCT8), (DCT8, DST7), (DST7, DCT8), and (DST7, DST7). Using (DCT2, DCT2) as an example, DCT2 represents the transform kernel of the horizontal transform, DCT2 represents the transform kernel of the vertical transform, and so on. (DCT8, DCT8), (DCT8, DST7), (DST7, DCT8), and (DST7, DST7) may be understood in the same mode.

Which transform combination is specifically selected for a transform block needs to be decided on the encoder side by using a rate-distortion optimization (RDO) rule. Although adaptive multi-kernel transform can improve adaptability of the transform block to the residual, a problem that comes with the adaptive multi-kernel transform is encoding costs of a transform kernel index (configured for indicating which transform kernel is used).
(2) Transform skip (TS): There are some residuals having a weak correlation in a video encoding process. For the residuals, transform skip may be performed based on (1), so that encoding efficiency is higher. In other words, a transform process of the residuals is skipped, and quantization is directly performed on the residuals.

### 2. Common Transform Partitioning Mode

In this embodiment of this application, when transform processing is performed on a coding unit, a plurality of common transform partitioning modes are involved. For example, the transform partitioning modes may include, but are not limited to: a residual quad tree (RQT) mode, a position based transform (PBT) mode, a sub-block transform (SBT) mode, and the like. Next, the RQT, the PBT, and the SBT are respectively described.

### \textcircled{1} RQT

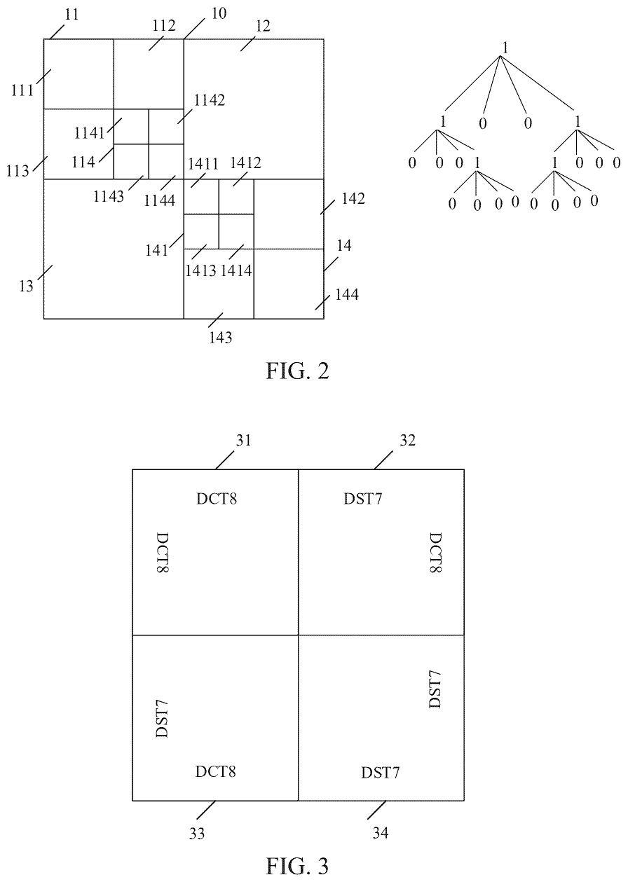

In the HEVC standard, the RQT divides the coding unit in a recursive quad tree mode, and encodes optimal partition information in a video bitstream for transmission. FIG. 2 is a schematic diagram of a residual quad tree partition mode according to an exemplary embodiment of this application. In FIG. 2, a left side is a schematic diagram of dividing a coding unit, and a right side is a tree structure after quad tree processing is performed on the coding unit, 1 representing partition and 0 representing no further partition. In FIG. 2, a coding unit 10 corresponds to 1, that is, the coding unit 10 is divided into four sub-blocks (that is, a sub-block 11, a sub-block 12, a sub-block 13, and a sub-block 14 in FIG. 2) through quadruple partition. The first sub-block (that is, the sub-block 11) corresponds to 1, that is, the sub-block 11 is further divided into four sub-blocks (a sub-block 111, a sub-block 112, a sub-block 113, and a sub-block 114) through quadruple partition. The second sub-block (that is, the sub-block 12) corresponds to 0, and the third sub-block (the sub-block 13) corresponds to 0, that is, neither the sub-block 12 nor the sub-block 13 is further divided. The fourth sub-block (that is, the sub-block 14) corresponds to 1, and the sub-block 14 is further divided into four sub-blocks (a sub-block 141, a sub-block 142, a sub-block 143, and a sub-block 144) through quadruple partition. The sub-block 111, the sub-block 112, and the sub-block 113 all correspond to 0, which means that the sub-block 111, the sub-block 112, and the sub-block 113 are not further divided. The sub-block 114 corresponds to 1, which means that the sub-block 114 is further divided into four sub-blocks (a sub-block 1141, a sub-block 1142, a sub-block 1143, and a sub-block 1144) through quadruple partition. The sub-block 1141, the sub-block 1142, the sub-block 1143, and the sub-block 1144 all correspond to 0, which means that the sub-block 1141, the sub-block 1142, the sub-block 1143, and the sub-block 1144 are not further divided. The sub-block 141 corresponds to 1, which means that the sub-block 141 is further divided into four sub-blocks (a sub-block 1411, a sub-block 1412, a sub-block 1413, and a sub-block 1414) through quadruple partition. The sub-block 1411, the sub-block 1412, the sub-block 1413, and the sub-block 1414 all correspond to 0, which means that the sub-block 1411, the sub-block 1412, the sub-block 1413, and the sub-block 1414 are not further divided.

In FIG. 2, if transform partitioning processing is performed on the coding unit by using the RQT, the transform partitioning mode of the coding unit needs many bits (that is, a long code length) to represent.

### \textcircled{2} PBT

FIG. 3 is a schematic diagram of a position based sub-block transform according to an exemplary embodiment of this application. As shown in FIG. 3, in the AVS3 standard, the position based sub-block transform may divide a coding unit into four sub-blocks (that is, a sub-block 31, a sub-block 32, a sub-block 33, and a sub-block 34 in FIG. 3) through quadruple partition, and a transform combination is preset according to a position of each sub-block. The transform combination may include a transform kernel of a horizontal transform and a transform kernel of a vertical transform. The transform kernel of the horizontal transform and the transform kernel of the vertical transform may be the same or different. For example, as shown in FIG. 3, a transform combination of a sub-block 31 is (DCT8, DCT8), a transform combination of a sub-block 32 is (DST7, DCT8), a transform combination of a sub-block 33 is (DCT8, DST7), and a transform combination of a sub-block 33 is (DST7, DST7).

Whether the PBT is used for any coding unit (for example, a current coding unit) may be adaptively identified by using one flag. In an implementation, if the flag is a first value (for example, 1), the current coding unit uses the PBT; and if the flag is a second value (for example, 0), the PBT is not used for the current coding unit.

### \textcircled{3} SBT

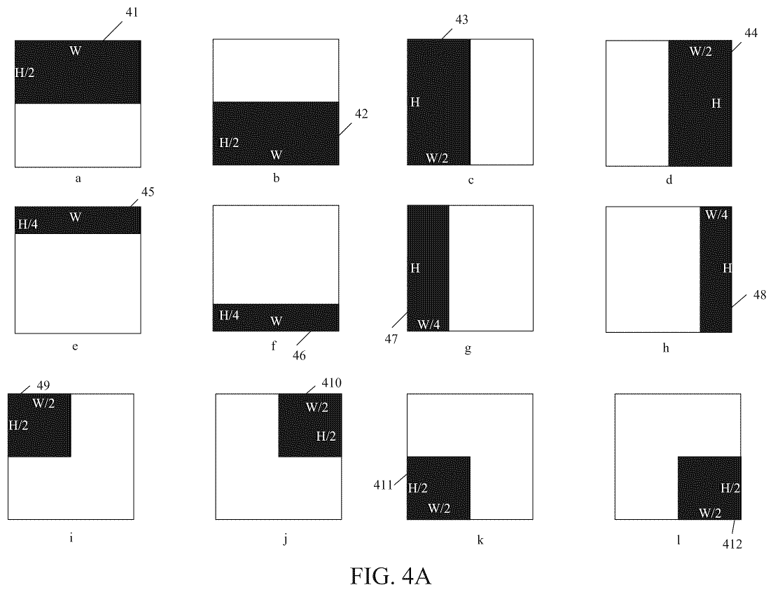

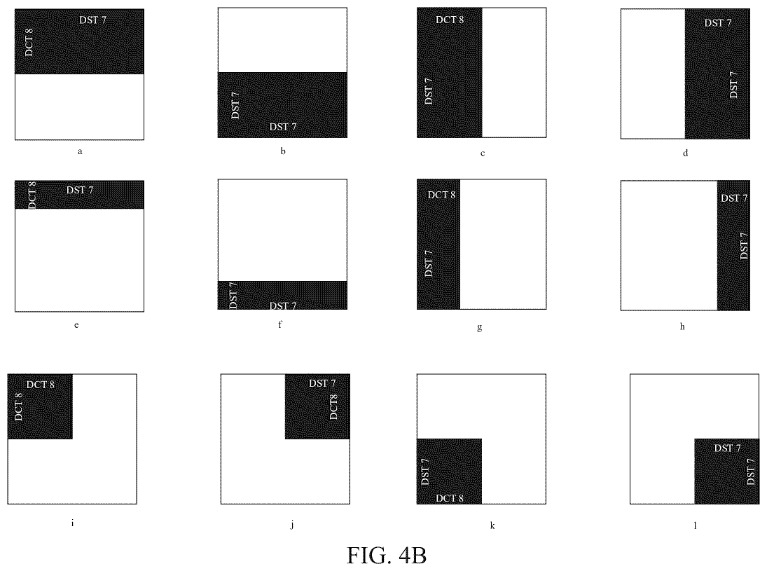

FIG. 4A is a schematic diagram of a sub-block transform according to an exemplary embodiment of this application. As shown in FIG. 4A, the SBT corresponds to 12 residual position modes (that is, residual position modes a to l in FIG. 4A), and each residual position mode transforms only some sub-block regions. For example, the residual position mode a transforms only a sub-block region 41 marked by using a color, the residual position mode b transforms only a sub-block region 42 marked by using the color, the residual position mode c transforms only a sub-block region 43 marked by using the color, the residual position mode d transforms only a sub-block region 44 marked by using the color, the residual position mode e transforms only a sub-block region 45 marked by using the color, the residual position mode f transforms only a sub-block region 46 marked by using the color, the residual position mode g transforms only a sub-block region 47 marked by using the color, the residual position mode h transforms only a sub-block region 48 marked by using the color, the residual position mode i transforms only a sub-block region 49 marked by using the color, the residual position mode j transforms only a sub-block region 410 marked by using the color, the residual position mode k transforms only a sub-block region 411 marked by using the color, and the residual position mode l transforms only a sub-block region 412 marked by using the color.

In specific implementation, in each residual position mode, a sub-block region that needs to be transformed is not further divided, but is directly transformed and quantized; and a sub-block region that does not need to be transformed is zeroed out. For example, using the residual position mode a as an example, in FIG. 4A, transform is performed on only the sub-block region 41 in the residual position mode a, and a region other than the sub-block region 41 in the residual position mode a is zeroed out. The sub-block region which needs to be transformed is referred to as a sub-block transform region, and the 12 residual position modes respectively correspond to sub-block transform regions at different positions.

A size of the sub-block transform region may be 1, ½, or ¼ of a size in a direction corresponding to a coding unit at which the sub-block transform region is located. The size includes a width and a height, and the direction corresponding to the coding unit may include at least one of the following: a direction corresponding to a width of the coding unit, and a direction corresponding to a height of the coding unit. For example, the width of the coding unit is W, and the height of the coding unit is H. A size of a sub-block transform region corresponding to the first row in FIG. 4A is ½ of a size in a direction corresponding to the coding unit at which the sub-block transform region is located. For example, for the residual position mode a in FIG. 4A, a width of the sub-block transform region is equal to the width of the coding unit, and a height of the sub-block transform region is equal to ½ of the height of the coding unit, that is, the height of the sub-block transform region is H/2. For another example, for the residual position mode c in FIG. 4A, a width of the sub-block transform region is equal to ½ of the width of the coding unit, that is, the width of the sub-block transform region is W/2, and a height of the sub-block transform region is equal to the height of the coding unit. A sizes of each sub-block transform region corresponding to the second row and the third row in FIG. 4A is ¼ of a size in a corresponding direction of a coding unit in which the sub-block transform region is located. For example, for the residual position mode e in FIG. 4A, a width of the sub-block transform region is equal to the width of the coding unit, and a height of the sub-block transform region is equal to ¼ of the height of the coding unit, that is, the height of the sub-block transform region is H/4. For another example, for the residual position mode k in FIG. 4A, a width of the sub-block transform region is equal to ½ of the width of the coding unit, that is, the width of the sub-block transform region is W/2, and a height of the sub-block transform region is equal to ½ of the height of the coding unit, that is, the height of the sub-block transform region is H/2.

In this embodiment of this application, for the 12 residual position modes corresponding to the SBT, a corresponding transform combination may be set for each residual position mode. FIG. 4B is a schematic diagram of a transform combination corresponding to each residual position mode in 12 residual position modes according to an exemplary embodiment of this application. In FIG. 4B, a transform combination corresponding to the residual position mode a may be (DST7, DCT8), a transform combination corresponding to the residual position mode b may be (DST7, DST7), a transform combination corresponding to the residual position mode c may be (DCT8, DST7), a transform combination corresponding to the residual position mode d may be (DST7, DST7), a transform combination corresponding to the residual position mode e may be (DST7, DCT8), a transform combination corresponding to the residual position mode f may be (DST7, DST7), a transform combination corresponding to the residual position mode g may be (DCT8, DST7), a transform combination corresponding to the residual position mode h may be (DST7, DST7), a transform combination corresponding to the residual position mode i may be (DCT8, DCT8), a transform combination corresponding to the residual position mode j may be (DST7, DCT8), a transform combination corresponding to the residual position mode k may be (DCT8, DST7), and a transform combination corresponding to the residual position mode l may be (DST7, DST7).

Using an example in which the transform combination corresponding to the residual position mode a is (DST7, DCT8), DST7 in (DST7, DCT8) is the transform kernel of the horizontal transform, and DCT8 is the transform kernel of the vertical transform. For other residual position modes, refer to the residual position mode a for understanding, and details are not described herein again. The decoder side only needs to decode transform information of the sub-block transform region, and performs inverse transform and inverse quantization based on the transform information of the sub-block transform region. A residual corresponding to a sub-block region other than the sub-block transform region (that is, a sub-block region on which transform is not performed) is set to 0 by default. As can be seen from FIG. 4A and FIG. 4B, the SBT corresponds to a plurality of residual position modes, and also needs many bits to identify a residual position mode used by the current coding unit, which consumes a large amount of bit rate to some extent.

When residual transform is performed on the coding unit, transform coefficients of some sub-block regions in the coding unit after residual transform is performed are 0, and transform coefficients of other sub-block regions after residual transform is performed are not 0. The residual transform corresponding to a transform coefficient not being 0 may be referred to as non-zero transform.

### 3. Video Decoding

On a decoder side, for each coding unit, after a video bitstream is obtained, entropy decoding is first performed on the video bitstream, to obtain information about various prediction modes and quantized transform coefficients, and then inverse quantization and inverse transform are performed on each transform coefficient, to obtain a residual. In addition, a prediction signal corresponding to the coding unit may be obtained according to the known information about the prediction modes, and the residual and the prediction signal are added to obtain a reconstructed video signal. The reconstructed video signal may be configured for reconstructing a decoded image corresponding to the coding unit. A loop filtering operation needs to be performed on the reconstructed video signal, to generate a final output signal.

The video encoding and decoding solution provided in this embodiment of this application may be applied to a video codec (for example, a video codec using a sub-block transform technology) or a video compression product.

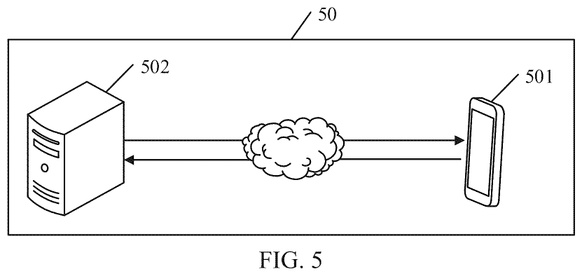

FIG. 5 is a schematic architectural diagram of a video encoding and decoding system according to an embodiment of this application. A video encoding and decoding system 50 may include an encoding device 501 and a decoding device 502. The encoding device 501 is located at an encoder side, and the decoding device 502 is located at a decoder side. The encoding device 501 may be a terminal, or may be a server. The decoding device 502 may be a terminal, or may be a server. A communication connection may be established between the encoding device 501 and the decoding device 502. The terminal may be a smartphone, a tablet computer, a notebook computer, a desktop computer, a smart speaker, a smartwatch, an in-vehicle terminal, a smart television, or the like, but is not limited thereto. The server may be an independent physical server, a server cluster including a plurality of physical servers, a distributed system, or a cloud server that provides basic cloud computing services such as a cloud service, a cloud database, cloud computing, a cloud function, cloud storage, a network service, cloud communication, a middleware service a domain name service, a security service, a content delivery network (CDN), big data, and an AI platform.

### (1) For the Encoding Device 501:

The encoding device 501 may obtain a to-be-encoded video. The video may be obtained through shooting by a camera device or computer generation. The camera device may be a hardware component disposed in the encoding device 501. For example, the encoding device 501 is a terminal, and the camera device may be an ordinary camera, a 3D camera, a light field camera, or the like disposed in the terminal. The camera device may also refer to a hardware apparatus connected to the encoding device 501. For example, the encoding device 501 is a server, and the camera device may be a camera connected to the server.

A video includes one or more video frames, and the encoding device 501 may divide each video frame into one or more coding units and encode each coding unit. When any coding unit is encoded, an adjacent coding unit of a coding unit being encoded (subsequently referred to as a current coding unit) may be determined, and transform information of the current coding unit may be determined based on encoding information of the adjacent coding unit. The adjacent coding unit is a coding unit on which transform partitioning processing is performed. The encoding information of the adjacent coding unit may include at least one of the following: transform information (such as a transform partitioning mode and a transform combination) of the adjacent coding unit, a residual of the adjacent coding unit, a transform coefficient of the adjacent coding unit, or the like. In this case, the transform information of the current coding unit may be determined based on the encoding information of the adjacent coding unit in the following two modes:
\textcircled{1} The encoding information of the adjacent coding unit includes the transform information of the adjacent coding unit. In this implementation, the current coding unit may directly inherit the transform information of the adjacent coding unit. The inheriting means that the transform information of the adjacent coding unit is directly determined as the transform information of the current coding unit.
\textcircled{2} The encoding information of the adjacent coding unit includes a residual or a transform coefficient of the adjacent coding unit, and the transform information of the current coding unit includes a residual position mode of the current coding unit in the SBT. In this implementation, the encoding device 501 may deduce, according to the residual or the transform coefficient of the adjacent coding unit, a residual position mode in which a coding residual of the current coding unit is transformed in the SBT mode.

After the transform information of the current coding unit is determined, the encoding device 501 may encode the current coding unit based on the determined transform information of the current coding unit, to obtain a video bitstream. For example, the transform information of the current coding unit includes the transform partitioning mode. The encoding device 501 may perform transform partitioning on the current coding unit based on the transform partitioning mode, to obtain a transform coefficient of the current coding unit, and perform operations such as quantization and entropy encoding on the transform coefficient of the current coding unit, to obtain the video bitstream. After the video bitstream is obtained, the video bitstream may be sent to the decoding device 502, so that the decoding device 502 decodes the video bitstream.

### (2) For the Decoding Device 502:

After the video bitstream sent by the encoding device 501 is received, the decoding device 502 may determine a current coding unit in the video bitstream, the current coding unit being a coding unit being decoded, determine an adjacent coding unit of the current coding unit, and determine transform information of the current coding unit according to encoding information of the adjacent coding unit.

The decoding device may determine the transform information of the current coding unit based on the encoding information of the adjacent coding unit in the following two modes:
\textcircled{1} The encoding information of the adjacent coding unit includes transform information of the adjacent coding unit. In this implementation, the current coding unit may directly inherit the transform information of the adjacent coding unit.
\textcircled{2} The encoding information of the adjacent coding unit includes a residual or a transform coefficient of the adjacent coding unit, and the transform information of the current coding unit includes a residual position mode of the current coding unit in the SBT. In this implementation, the decoding device 502 may deduce, according to the residual or the transform coefficient of the adjacent coding unit, a residual position mode in which a coding residual of the current coding unit is transformed in the SBT mode.

After the transform information of the current coding unit is determined, the decoding device 502 may decode the current coding unit based on the determined transform information of the current coding unit, to reconstruct a video frame in which the current coding unit is located. In an implementation, the transform information of the current coding unit includes a transform partitioning mode. The decoding device 502 may perform inverse transform processing on the current coding unit based on the transform partitioning mode, to obtain a residual of the current coding unit. The residual of the current coding unit may be configured for reconstructing the video frame in which the current coding unit is located. In another implementation, the transform information of the current coding unit includes the residual position mode in which the coding residual of the current coding unit is transformed in the SBT mode. The decoding device 502 may perform inverse transform processing on the current coding unit based on the residual position mode, to obtain the residual of the current coding unit. The residual of the current coding unit may be configured for reconstructing the video frame in which the current coding unit is located.

In this embodiment of this application, in a video encoding and decoding process, the transform information of the current coding unit may be determined based on the encoding information of the adjacent coding unit. In this way, encoding costs consumed for encoding the transform information of the current coding unit can be reduced, thereby reducing bit rate consumption in an entire encoding and decoding process, and further improving encoding and decoding efficiency.

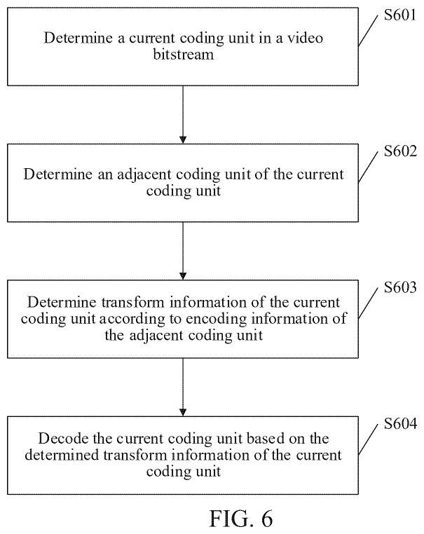

FIG. 6 is a schematic flowchart of a video decoding method according to an exemplary embodiment of this application. The video decoding method may be performed by the decoding device 502 in the foregoing video encoding and decoding system, and the video decoding method described in this embodiment may include the following operations S601 to S604:

S601: Determine a current coding unit in a video bitstream. The video bitstream includes one or more video frames, each video frame may include one or more coding units, and the current coding unit is a coding unit being decoded in the video bitstream.

S602: Determine an adjacent coding unit of the current coding unit.

The adjacent coding unit includes a spatially adjacent coding unit and/or a temporally adjacent coding unit.
i. The spatially adjacent coding unit is a coding unit adjacent to the current coding unit in a current frame of a video, and the current frame is a video frame in which the current coding unit is located; and the current coding unit is a coding unit being decoded in the current frame.

The determining an adjacent coding unit of the current coding unit may include: searching a current frame of a video for a coding unit adjacent to the current coding unit, and determining the coding unit adjacent to the current coding unit as a spatially adjacent coding unit of the current coding unit. The “adjacent” herein may mean that there is at least one vertex or one edge overlapped between the coding unit and the current coding unit, and there may be one or more spatially adjacent coding units.

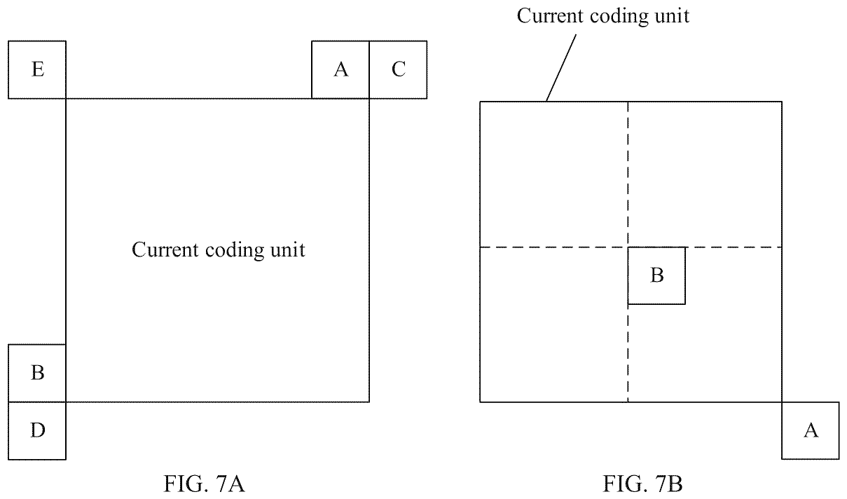

The searching a current frame of a video for a coding unit adjacent to the current coding unit may include: searching the current frame of the video for a transform block adjacent to the current coding unit, and determining a coding unit in which the transform block adjacent to the current coding unit is located as the coding unit adjacent to the current coding unit. The transform block is a small block obtained after the coding unit is divided by using a residual basic unit. The residual basic unit may include a 4×4 pixel block, an 8×8 pixel block, or the like. In other words, the transform block may be a 4×4 small block, an 8×8 small block, or the like in the coding unit. For example, FIG. 7A is a schematic diagram of a transform block adjacent to a current coding unit according to an exemplary embodiment of this application. In FIG. 7A, A, B, C, D, and E are transform blocks. A, B, C, D, E, and the current coding unit are all located in the current frame. In the current frame of the video, the transform blocks adjacent to the current coding unit are found to include A, B, C, D, and E. In this case, coding units in which the transform blocks A to E are located may be determined as the spatially adjacent coding units of the current coding unit.
ii. The temporally adjacent coding unit is a coding unit adjacent to a reference coding unit in a reference frame of the video; and there may be one or more temporally adjacent coding units. The reference frame is any video frame or a specified video frame in the video other than the current frame. In an implementation, this embodiment of this application provides a reference frame list. The reference frame list includes one or more video frames of the video. The reference frame may be any video frame in the reference frame list. For example, the video frames in the reference frame list are sequentially arranged, and the reference frame may be the first video frame in the reference frame list. In another implementation, the reference frame may be a video frame specified in a sequence header of the video bitstream or a frame header of the current frame in which the current coding unit is located.

A position of the reference coding unit in the reference frame is the same as a position of the current coding unit in the current frame. For example, for a position A of the current coding unit in the current frame, the position of the reference coding unit in the reference frame is the same as the position A.

In an implementation, the determining an adjacent coding unit of the current coding unit may include: determining a reference frame corresponding to a current frame, mapping the current coding unit in the current frame to the reference frame to obtain a reference coding unit in the reference frame that has the same position as the current coding unit, searching the reference frame for a coding unit adjacent to the reference coding unit, and determining the found coding unit adjacent to the reference coding unit as a temporally adjacent coding unit of the current coding unit.

The searching the reference frame for a coding unit adjacent to the reference coding unit may be in the following mode: searching the reference frame for a transform block adjacent to the reference coding unit, and determining a coding unit in which the transform block adjacent to the reference coding unit is located as the coding unit adjacent to the reference coding unit, the transform block being a 4×4 small block, an 8×8 small block, or the like in the coding unit. For example, FIG. 7B is a schematic diagram of a transform block adjacent to a current coding unit according to another exemplary embodiment of this application. In FIG. 7B, the current coding unit in the current frame is mapped to the reference frame, to obtain the reference coding unit in the reference frame that has the same position as the current coding unit. Then, the reference frame is searched for the transform block adjacent to the reference coding unit. As shown in FIG. 7B, the transform blocks adjacent to the reference coding unit are found in the reference frame to be A and B. In this case, a coding unit in which the transform block A is located and a coding unit in which the transform block B is located may be determined as the temporally adjacent coding units of the current coding unit.

S603: Determine transform information of the current coding unit according to encoding information of the adjacent coding unit.

The encoding information includes at least one of the following: transform information, a residual, or a transform coefficient. The transform information includes at least one of a transform partitioning mode or a transform combination. The transform partitioning mode includes at least one of the following: RQT, PBT, or SBT. The transform combination includes a transform kernel of a horizontal transform and a transform kernel of a vertical transform, and the transform kernel includes at least one of the following: a discrete cosine transform kernel (for example, DCT2 or DCT8), a discrete sine transform kernel (DST7), or transform skip (for example, TS). The determining transform information of the current coding unit according to encoding information of the adjacent coding unit may include, but is not limited to, the following two modes (mode 1) and mode 2)):
1) The current coding unit directly inherits transform information of the adjacent coding unit.

The encoding information of the adjacent coding unit includes the transform information of the adjacent coding unit, and the determining transform information of the current coding unit according to encoding information of the adjacent coding unit includes: determining the transform information of the adjacent coding unit as the transform information of the current coding unit.

In an implementation, when the transform information of the adjacent coding unit includes the transform partitioning mode, the transform partitioning mode of the adjacent coding unit may be determined as the transform partitioning mode of the current coding unit. In other words, the current coding unit may inherit the transform partitioning mode of the adjacent coding unit. For example, if the transform partitioning mode of the adjacent coding unit is the RQT, an optimal partition mode of the RQT of the adjacent coding unit may be determined as the transform partitioning mode of the current coding unit. In other words, the current coding unit directly inherits the optimal partition mode of the RQT of the adjacent coding unit. The optimal partition mode may be a partition mode having a smallest rate-distortion cost. For another example, if the transform partitioning mode of the adjacent coding unit is the SBT, the SBT of the adjacent coding unit may be determined as the transform partitioning mode of the current coding unit. In other words, the current coding unit inherits the SBT of the adjacent coding unit.

In another implementation, when the transform information of the adjacent coding unit includes the transform partitioning mode and the transform combination, the transform partitioning mode and the transform combination of the adjacent coding unit may be determined as the transform information of the current coding unit. In other words, the current coding unit inherits the transform partitioning mode of the adjacent coding unit and a transform combination corresponding to the transform partitioning mode. For example, the transform partitioning mode of the adjacent coding unit is the PBT, a transform combination corresponding to the PBT is shown in FIG. 3, and the transform combination corresponding to the PBT includes: the transform combination (DCT8, DCT8) corresponding to the sub-block 31, the transform combination (DST7, DCT8) corresponding to the sub-block 32, the transform combination (DCT8, DST7) corresponding to the sub-block 33, and the transform combination (DST7, DST7) corresponding to the sub-block 34. In this way, the PBT of the adjacent coding unit and a transform combination corresponding to the PBT may be determined as the transform information of the current coding unit. In other words, the current coding unit inherits the PBT of the adjacent coding unit and the transform combination corresponding to the PBT.

Both encoding and decoding parties may agree on determining the transform information of the adjacent coding unit as the transform information of the current coding unit. Alternatively, in some implementations, a series of control methods may be used to control whether a transform inheritance mode is enabled for the current coding unit, thereby determining the transform information of the adjacent coding unit as the transform information of the current coding unit. In this implementation, the decoding device may detect whether the transform inheritance mode is enabled for the current coding unit, and if it is determined the transform inheritance mode is enabled for the current coding unit, the transform information of the adjacent coding unit is determined as the transform information of the current coding unit. A control method for enabling the transform inheritance mode may include at least one of the following (1) or (2):
(1) Set a transform inheritance mode flag in the video bitstream, and instruct to enable the transform inheritance mode for the current coding unit when the transform inheritance mode flag is a first preset value (such as 1); and instruct to disable the transform inheritance mode for the current coding unit when the transform inheritance mode flag is a second preset value (such as 0). A setting position of the transform inheritance mode flag in the video bitstream may include at least one of the following:
a. The transform inheritance mode flag is set in a sequence header of the video, to implement signal control at a sequence level. When the transform inheritance mode flag in the sequence header is a first preset value, the transform inheritance mode is instructed to be enabled for all coding units in all video frames of the video; and when the transform inheritance mode flag in the sequence header is a second preset value, the transform inheritance mode is instructed to be disabled for all the coding units in all the video frames.
b. The transform inheritance mode flag is set in a frame header of the current frame of the video, to implement signal control at an image level. When the transform inheritance mode flag in the frame header of the current frame is a first preset value, the transform inheritance mode is instructed to be enabled for all coding units in the current frame; and when the transform inheritance mode flag in the frame header of the current frame is a second preset value, the transform inheritance mode is instructed to be disabled for all the coding units in the current frame.
c. The transform inheritance mode flag is set in a strip header of a strip in which the current coding unit is located, to implement signal control at a strip level. When the transform inheritance mode flag in the strip header is a first preset value, the transform inheritance mode is instructed to be enabled for all coding units in the strip header; and when the transform inheritance mode flag in the strip header is a second preset value, the transform inheritance mode is instructed to be disabled for all the coding units in the strip header. The strip is a combination of a plurality of coding units.
d. The transform inheritance mode flag is set in a coding tree unit in which the current coding unit is located, to implement signal control at a CTU level. When the transform inheritance mode flag in the coding tree unit is a first preset value, the transform inheritance mode is instructed to be enabled for all coding units in the coding tree unit; and when the transform inheritance mode flag in the coding tree unit is a second preset value, the transform inheritance mode is instructed to be disabled for all the coding units in the coding tree unit.
e. The transform inheritance mode flag is set in the current coding unit, to implement signal control of the coding unit. When the transform inheritance mode flag in the current coding unit is a first preset value, the transform inheritance mode is instructed to be enabled for all coding units in the current coding unit; and when the transform inheritance mode flag in the current coding unit is a second preset value, the transform inheritance mode is instructed to be disabled for all the coding units in the current coding unit.
(2) Set an enabling condition of the transform inheritance mode, and instruct to enable the transform inheritance mode for the current coding unit when the current coding unit satisfies the enabling condition; and instruct to disable the transform inheritance mode for the current coding unit when the current coding unit does not satisfy the enabling condition, the enabling condition including at least one of the following: a size condition or a prediction condition.
f. The enabling condition includes a size condition, the size condition is configured for defining a preset width threshold or a preset height threshold for enabling the transform inheritance mode, and the preset width threshold and the preset height threshold may be set according to requirements. This is not limited in the embodiments of this application. That the current coding unit satisfies the enabling condition includes any one of the following:
\textcircled{1} when the size condition defines the preset width threshold, a width of the current coding unit is greater than the preset width threshold;
\textcircled{2} when the size condition defines the preset height threshold, a height of the current coding unit is greater than the preset height threshold;
\textcircled{3} when the size condition defines the preset width threshold, the width of the current coding unit is less than the preset width threshold; and
\textcircled{4} when the size condition defines the preset height threshold, the height of the current coding unit is less than the preset height threshold.
g. The enabling condition includes a prediction condition. In this implementation, that the current coding unit satisfies the enabling condition includes: the adjacent coding unit is a prediction reference coding unit of the current coding unit. In other words, a coding unit which predicts by using prediction information of an adjacent coding unit a transform partitioning inheritance mode can be enabled for a coding unit which predicts by using prediction information of an adjacent coding unit. In this case, the adjacent coding unit is the prediction reference coding unit of the current coding unit.

Enabling and disabling of the transform partitioning inheritance mode for any coding unit may be independently controlled by one of the foregoing control methods a to g, or may be controlled by a combination of a plurality of (at least two) methods of the foregoing control methods a to g. For example, the control method includes: setting the transform inheritance mode flag in a sequence header of the video bitstream, and the height of the coding unit being greater than the preset height threshold. This means that the transform inheritance mode can be enabled for all coding units whose heights are greater than the preset height threshold in the video bitstream. For another example, the control method includes: the height of the coding unit being less than the preset height threshold, and the adjacent coding unit being a prediction reference coding unit of the coding unit. In this case, it means that the transform inheritance mode can be enabled for a coding unit in the video bitstream whose height is less than the preset height threshold and whose prediction is performed by using prediction information of the adjacent coding unit. A control method for enabling and disabling the transform partitioning inheritance mode of any coding unit is not limited in the embodiments of this application.

A quantity of adjacent coding units may be greater than or equal to 1. When the quantity of adjacent coding units is greater than 1, the decoding device determines, according to the encoding information of the adjacent coding units, that the transform information of the current coding unit may include s11 to s13:

s11: Perform deduplication processing on the adjacent coding units, to obtain N adjacent coding units.

In specific implementation, when at least two adjacent coding units whose transform information is the same exist in the adjacent coding units, deduplication processing may be performed on the at least two adjacent coding units, and only one of the at least two adjacent coding units is reserved. There may be N adjacent coding units remaining after deduplication processing, N being a positive integer. For example, the quantity of adjacent coding units is three, which are respectively an adjacent coding unit 1, an adjacent coding unit 2, and an adjacent coding unit 3. Transform information of the adjacent coding unit 1 is exactly the same as transform information of the adjacent coding unit 2. In this case, deduplication processing may be performed on the three adjacent coding units, to obtain two adjacent coding units. If the adjacent coding unit 1 is reserved, the remaining two adjacent coding units after deduplication processing include the adjacent coding unit 1 and the adjacent coding unit 3; and if the adjacent coding unit 2 is reserved, the remaining two adjacent coding units after deduplication processing include the adjacent coding unit 2 and the adjacent coding unit 3.

That the transform information is the same may include the following cases: \textcircled{1} When the transform information includes the transform partitioning mode, that the transform information is the same means that the transform partitioning modes are exactly the same. For example, if a transform partitioning mode of the adjacent coding unit 1 is the PBT, and a transform partitioning mode of the adjacent coding unit 2 is also the PBT, it may be determined that the transform information of the adjacent coding unit 1 is the same as the transform information of the adjacent coding unit 2. \textcircled{2} When the transform information includes the transform combination, that the transform information is the same means that transform combinations are exactly the same. For example, if a transform combination of the adjacent coding unit 1 is (DCT8, DCT8), and a transform combination of the adjacent coding unit 2 is also (DCT8, DCT8), it may be determined that the transform information of the adjacent coding unit 1 is the same as the transform information of the adjacent coding unit 2. \textcircled{3} When the transform information includes the transform partitioning mode and the transform combination, that the transform information is the same means that the transform partitioning modes and the transform combinations are exactly the same. For example, the transform partitioning mode of the adjacent coding unit 1 is the SBT, the transform combination of the adjacent coding unit 1 is a transform combination 1, the transform partitioning mode of the adjacent coding unit 2 is the SBT, and the transform combination is the transform combination 1. Therefore, it may be determined that the transform information of the adjacent coding unit 1 is the same as the transform information of the adjacent coding unit 2.

s12: Determine a target adjacent coding unit in the N adjacent coding units.

A method for determining the target adjacent coding unit includes any one of the following: \textcircled{1} In the video bitstream, a selecting identifier may be used to indicate which adjacent coding unit the current coding unit inherits the transform information from. In this implementation, if a selecting flag in the video bitstream includes an identifier of the adjacent coding unit that needs to be inherited, the decoding device may select the target adjacent coding unit corresponding to the identifier from the N adjacent coding units according to the selecting flag. The identifier of the adjacent coding unit includes a coding unit number and the like.
\textcircled{2} A prediction reference coding unit selected by a prediction mode of the current coding unit is selected as the target adjacent coding unit if the N adjacent coding units include at least one prediction reference coding unit of the current coding unit and the prediction mode of the current coding unit is coupled to the transform inheritance mode. That the prediction mode of the current coding unit is coupled to the transform inheritance mode means that: the prediction mode of the current coding unit is associated with the transform inheritance mode. The prediction mode includes at least one of the following: an inter merge mode, an intra block copy merge (IBC merge) mode, an intra template matching merge (Intra TMP merge) mode, and an intra prediction mode.

Example 1: The prediction mode is a merge mode (for example, Inter merge). If a merge mode and the transform inheritance mode of the current coding unit are coupled, the prediction reference coding unit selected by the merge mode of the current coding unit may be selected from the at least one prediction reference coding unit as the target adjacent coding unit. If the prediction mode of the current coding unit is the Inter merge mode, and the Inter merge mode of the current coding unit selects the adjacent coding unit 1 from the N adjacent coding units for prediction reference, when the Inter merge mode and the transform inheritance mode of the current coding unit are coupled, the adjacent coding unit 1 may be used as the target adjacent coding unit.

Example 2: When the current coding unit is an intra block, and the intra prediction mode and the transform inheritance mode of the current coding unit are coupled, the prediction reference coding unit selected by the intra prediction mode of the current coding unit may be selected from the at least one prediction reference coding unit as the target adjacent coding unit. For example, the intra prediction mode of the current coding unit is exported from the adjacent coding unit 2 in the at least one prediction reference coding unit. In other words, if the intra prediction mode of the current coding unit selects the adjacent coding unit 2 from the N adjacent coding units for reference prediction, the adjacent coding unit 2 may be used as the target adjacent coding unit.

In this embodiment of this application, the prediction mode and the transform inheritance mode of the current coding unit may be coupled to each other or may be independent from each other. The “independent from each other” means that: The prediction mode and the transform inheritance mode of the current coding unit are not associated, and the prediction mode and the transform inheritance mode of the current coding unit need to be separately indicated. In other words, when the prediction mode and the transform inheritance mode of the current coding unit are independent from each other, an extra bit needs to be used to identify the transform inheritance mode. This results in high bit rate consumption in the encoding and decoding process. When the prediction mode and the transform inheritance mode of the current coding unit are mutually coupled, the prediction mode and the transform inheritance mode of the current coding unit are associated. Therefore, the prediction mode and the transform inheritance mode of the current coding unit do not need to be separately indicated. In other words, the transform inheritance mode does not need to be indicated by using the extra bit, thereby reducing the bit rate consumption in the encoding and decoding process and improving encoding and decoding efficiency.

s13: Determine transform information of the target adjacent coding unit as the transform information of the current coding unit.
2) The encoding information of the adjacent coding unit includes a residual or a transform coefficient of the adjacent coding unit. In this embodiment of this application, a residual position mode when the current coding unit uses the SBT may be deduced by using the residual or the transform coefficient of the adjacent coding unit. The residual position mode is configured for indicating a sub-block region in which transform encoding residual is performed. The residual position mode when the current coding unit uses the SBT may be quickly deduced by using the residual or the transform coefficient of the adjacent coding unit, thereby improving the encoding and decoding efficiency in the encoding and decoding process.

In this implementation, the determining transform information of the current coding unit according to encoding information of the adjacent coding unit may include the following two modes:

Mode 1: Deduce one or more pieces of context index information according to the encoding information of the adjacent coding unit, each piece of context index information corresponding to an entropy decoding mode, for example, the entropy decoding mode may be CABAC decoding; and the decoding device determines an entropy decoding mode according to the deduced context index information, and performs entropy decoding on a residual position mode flag of the current coding unit in the SBT according to the determined entropy decoding mode, to obtain the residual position mode of the current coding unit in the SBT.

The deducing one or more pieces of context index information according to the encoding information of the adjacent coding unit may include: \textcircled{1} obtaining a first adjacent coding unit and a second adjacent coding unit of the current coding unit, the first adjacent coding unit being an adjacent coding unit located in a first direction of the current coding unit; \textcircled{2} the second adjacent coding unit being an adjacent coding unit located in a second direction of the current coding unit; \textcircled{3} obtaining a first quantity ratio of the first adjacent coding unit, the first quantity ratio being a ratio of a quantity of non-zero residual basic units included in the first adjacent coding unit to a total quantity of all residual basic units in the first adjacent coding unit; \textcircled{4} obtaining a second quantity ratio of the second adjacent coding unit, the second quantity ratio being a ratio of a quantity of non-zero residual basic units included in the second adjacent coding unit to a total quantity of all residual basic units in the second adjacent coding unit; and \textcircled{5} determining the context index information according to a magnitude relationship between the first quantity ratio and the second quantity ratio, if the first quantity ratio is greater than the second quantity ratio, the context index information being first index information, if the first quantity ratio is equal to the second quantity ratio, the context index information being second index information, and if the first quantity ratio is less than the second quantity ratio, the context index information being third index information.

The first direction and the second direction may be determined according to requirements. For example, the first direction may be located above the current coding unit, and the second direction may be located to the left of the current coding unit. For another example, the first direction may be located below the current coding unit, and the second direction may be located to the right of the current coding unit. The first direction and the second direction are not limited in the embodiments of this application. The non-zero residual basic unit is a residual basic unit on which non-zero transform exists. The residual basic unit may be a 4×4 pixel block and an 8×8 pixel block. The first index information, the second index information, and the third index information may be flexibly set. For example, the first index information may be 0, the second index information may be 1, and the third index information may be 2.

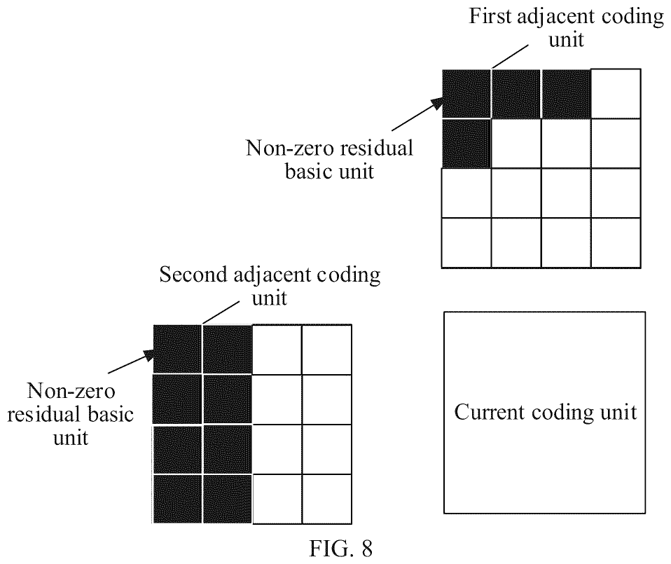

For example, FIG. 8 is a schematic diagram of a position relationship between a first adjacent coding unit and a current coding unit and a position relationship between a second adjacent coding unit and the current coding unit according to an exemplary embodiment of this application. In FIG. 8, the first adjacent coding unit is an adjacent coding unit located above the current coding unit, the second adjacent coding unit is an adjacent coding unit located on a left side of the current coding unit, the first adjacent coding unit and the second adjacent coding unit include the non-zero residual basic unit, and the residual basic unit is a 4×4 pixel block. The decoding device may obtain that the quantity of non-zero residual basic units included in the first adjacent coding unit is 4, the total quantity of all residual basic units included in the first adjacent coding unit is 16, and may determine that the first quantity ratio r1 in the first adjacent coding unit is 0.25; and the decoding device obtains that the quantity of non-zero residual basic units included in the second adjacent coding unit is 8, the total quantity of all residual basic units in the second adjacent coding unit is 16, and the second quantity ratio r2 in the second adjacent coding unit is 0.5. In this case, r1 is less than r2, and the context index information is 2.

Mode 2: The video bitstream includes index information of the residual position mode selected for the current coding unit in the SBT. The SBT includes a plurality of candidate residual position modes, and the plurality of candidate residual position modes may be, for example, the 12 residual position modes shown in FIG. 4A. In this implementation, the determining transform information of the current coding unit according to encoding information of the adjacent coding unit includes the following operations s21 to s23:

s21: Reorder each candidate residual position mode in the SBT according to the encoding information of the adjacent coding unit, to obtain a reordering list, the reordering list including each candidate residual position mode arranged in order and index information corresponding to each candidate residual position mode.

In an implementation, the reordering each candidate residual position mode in the SBT according to the encoding information of the adjacent coding unit, to obtain a reordering list includes: obtaining, by a decoding device, index information of each candidate residual position mode in the SBT according to the encoding information of the adjacent coding unit, and reordering the candidate residual position modes in the SBT according to a descending order of the index information, to obtain the reordering list.

The candidate residual position modes in the SBT respectively correspond to sub-block transform regions at different positions. For example, the candidate residual position mode is a candidate residual position mode a in FIG. 4A, and a sub-block transform region corresponding to the candidate residual position mode a is the region 41. For another example, the candidate residual position mode is a candidate residual position mode j in FIG. 4A, and a sub-block transform region corresponding to the candidate residual position mode j is the region 410. The obtaining index information of each candidate residual position mode in the SBT according to the encoding information of the adjacent coding unit includes: \textcircled{1} obtaining a first adjacent coding unit and a second adjacent coding unit of the current coding unit, the first adjacent coding unit being an adjacent coding unit located in a first direction of the current coding unit, and the second adjacent coding unit being an adjacent coding unit located in a second direction of the current coding unit; \textcircled{2} obtaining a first quantity ratio of the first adjacent coding unit, the first quantity ratio being a ratio of a quantity of non-zero residual basic units included in the first adjacent coding unit to a total quantity of all residual basic units in the first adjacent coding unit; \textcircled{3} obtaining a second quantity ratio of the second adjacent coding unit, the second quantity ratio being a ratio of a quantity of non-zero residual basic units included in the second adjacent coding unit to a total quantity of all residual basic units in the second adjacent coding unit; and \textcircled{4} allocating the index information to each candidate residual position mode in the SBT according to a magnitude relationship between the first quantity ratio and the second quantity ratio.

The first direction and the second direction may be determined according to requirements. For example, the first direction may be located above the current coding unit, and the second direction may be located to the left of the current coding unit. For another example, the first direction may be located below the current coding unit, and the second direction may be located to the right of the current coding unit. This is not limited in the embodiments of this application. The residual basic unit may be a 4×4 pixel block and an 8×8 pixel block.

The allocating the index information to each candidate residual position mode in the SBT according to a magnitude relationship between the first quantity ratio and the second quantity ratio includes the following cases:
(1) If the first quantity ratio is greater than or equal to the second quantity ratio, index information allocated to a candidate residual position mode whose sub-block transform region is located in the first direction is greater than index information allocated to a candidate residual position mode whose sub-block transform region is located in the second direction. For example, the first direction is located above the current coding unit, the second direction is located on the left side of the current coding unit, the first quantity ratio is r1, the second quantity ratio is r2, and r1>r2. Higher index information is allocated to a candidate residual position mode whose sub-block transform region is located above the current coding unit. In other words, the index information allocated to the candidate residual position mode whose sub-block transform region is located above the current coding unit is greater than index information allocated to the candidate residual position mode whose sub-block transform region is located on the left side of the current coding unit. For example, the candidate residual position mode whose sub-block transform region is located above the current coding unit may include the residual position mode a and the residual position mode e in FIG. 4A; and the candidate residual position mode whose sub-block transform region is located on the left side of the current coding unit may include the residual position mode c and the residual position mode g in FIG. 4A. Therefore, index information allocated to the residual position mode a and the residual position mode e is greater than index information allocated to the residual position mode c and the residual position mode g.
(2) If the first quantity ratio is less than the second quantity ratio, the index information allocated to the candidate residual position mode whose sub-block transform region is located in the second direction is greater than the index information allocated to the candidate residual position mode whose sub-block transform region is located in the first direction. For example, r1<r2, higher index information is allocated to the candidate residual position mode whose sub-block transform region is located on the left side of the current coding unit. In other words, the index information allocated to the candidate residual position mode whose sub-block transform region is located on the left side of the current coding unit is greater than the index information allocated to the candidate residual position mode whose sub-block transform region is located above the current coding unit. For example, the candidate residual position mode whose sub-block transform region is located above the current coding unit may include the residual position mode a and the residual position mode e in FIG. 4A; and the candidate residual position mode whose sub-block transform region is located on the left side of the current coding unit may include the residual position mode c and the residual position mode g in FIG. 4A. Therefore, the index information allocated to the residual position mode c and the residual position mode g is greater than the index information allocated to the residual position mode a and the residual position mode e.

The candidate residual position mode to which the higher index information is allocated is considered to have a correlation with the residual position mode of the current coding unit in the SBT. Therefore, the larger the index information of the candidate residual position mode, the shorter the code length of the candidate residual position mode. A shorter code length of the candidate residual position mode indicates a higher probability that the candidate residual position mode is selected as the residual position mode of the current coding unit in the SBT. The code length is measured by using a quantity of bits. A longer code length indicates a larger quantity of bits used for encoding; and a shorter code length indicates a smaller quantity of bits used for encoding. For example, a variable length coding is used for encoding, and the candidate residual position mode includes a candidate residual position mode A, a candidate residual position mode B, and a candidate residual position mode C. Index information of the candidate residual position mode A is greater than index information of the candidate residual position mode B, and the index information of the candidate residual position mode B is greater than index information of the candidate residual position mode C. Therefore, when the variable length coding is used for encoding, the index information of the candidate residual position mode A may be encoded into 0, the index information of the candidate residual position mode B may be encoded into 10, and the index information of the candidate residual position mode C may be encoded into 11. In this case, that a code length of the candidate residual position mode A is the shortest means that a probability that the candidate residual position mode A is selected as the residual position mode of the current coding unit in the SBT is the highest.

s22: Perform entropy decoding on the video bitstream, to obtain the index information of the residual position mode selected for the current coding unit in the SBT, and determine, from the reordering list according to the index information of the residual position mode selected for the current coding unit in the SBT, the residual position mode of the current coding unit in the SBT. Specifically, the reordering list is searched for the candidate residual position mode corresponding to the index information of the residual position mode selected for the current coding unit in the SBT, and the found candidate residual position mode is determined as the residual position mode of the current coding unit in the SBT.

S604: Decode the current coding unit based on the determined transform information of the current coding unit.

In an implementation, the transform information includes the transform partitioning mode and/or the transform combination. The decoding device may perform inverse transform processing on the current coding unit based on the transform partitioning mode and/or the transform combination of the current coding unit, to obtain a residual of the current coding unit. The residual of the current coding unit may be configured for reconstructing the current frame.

In another implementation, the transform information includes a residual position mode selected by the current coding unit in the SBT, and the decoding device may perform inverse transform processing on the current coding unit based on the selected residual position mode, to obtain a residual of the current coding unit. The residual of the current coding unit may be configured for reconstructing the current frame.

In this embodiment of this application, in a video decoding process, the transform information of the current coding unit may be determined based on the encoding information of the adjacent coding unit. In this way, encoding costs consumed for encoding the transform information of the current coding unit can be reduced, thereby reducing bit rate consumption in an entire encoding and decoding process, and further improving decoding efficiency.

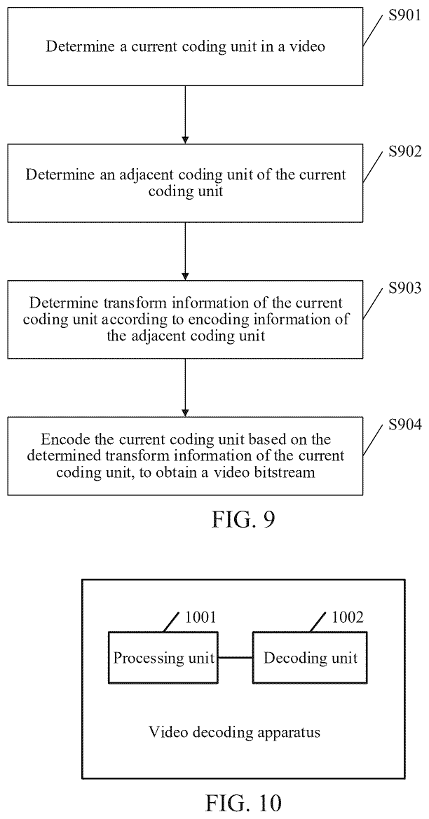

FIG. 9 is a schematic flowchart of a video encoding method according to another exemplary embodiment of this application. The video encoding method may be performed by the encoding device in the foregoing video encoding and decoding system, and the video encoding method described in this embodiment may include the following operations S901 to S904:

S901: Determine a current coding unit in a video.

The video includes one or more video frames, each video frame may include one or more coding units, and the current coding unit is a coding unit being encoded in the video.

S902: Determine an adjacent coding unit of the current coding unit.

The adjacent coding unit includes a spatially adjacent coding unit and/or a temporally adjacent coding unit, the spatially adjacent coding unit is a coding unit adjacent to the current coding unit in a current frame of the video, the current frame is a video frame in which the current coding unit is located, the current coding unit is a coding unit being encoded in the current frame, the temporally adjacent coding unit is a coding unit adjacent to a reference coding unit in a reference frame, the reference frame is any video frame or a specified video frame in the video other than the current frame, and a position of the reference coding unit in the reference frame is the same as a position of the current coding unit in the current frame.

A specific implementation of operation S902 is similar to that of operation S602, and details are not described herein again.

S903: Determine transform information of the current coding unit according to encoding information of the adjacent coding unit.

The encoding information of the adjacent coding unit includes at least one of the following: transform information, a residual, or a transform coefficient. The transform information includes a transform partitioning mode and/or a transform combination. The transform partitioning mode includes at least one of the following: PQT, PBT, or SBT. The transform combination includes a transform kernel of a horizontal transform and a transform kernel of a vertical transform, and the transform kernel includes at least one of the following: a discrete cosine transform kernel, a discrete sine transform kernel, or transform skip. The determining transform information of the current coding unit according to encoding information of the adjacent coding unit includes, but is not limited to, the following modes (mode 1) and mode 2)):
1) The current coding unit directly inherits transform information of the adjacent coding unit.

A quantity of adjacent coding units may be greater than or equal to 1. In this case, a video bitstream includes a selecting flag, and the selecting flag may specifically indicate the transform information of the adjacent coding unit that the current coding unit needs to inherit. After the transform information of the adjacent coding unit inherited by the current coding unit is determined, the encoding device sets, in the selecting flag, an identifier of the adjacent coding unit that needs to be inherited.

When the encoding information of the adjacent coding unit includes the transform information of the adjacent coding unit, and the determining transform information of the current coding unit according to encoding information of the adjacent coding unit includes: determining the transform information of the adjacent coding unit as the transform information of the current coding unit. In an implementation, when the transform information of the adjacent coding unit includes the transform partitioning mode, the transform partitioning mode of the adjacent coding unit may be determined as the transform partitioning mode of the current coding unit. In other words, the current coding unit may inherit the transform partitioning mode of the adjacent coding unit. In another implementation, when the transform information of the adjacent coding unit includes the transform partitioning mode and the transform combination, the transform partitioning mode and the transform combination of the adjacent coding unit may be determined as the transform partitioning mode and the transform combination of the current coding unit. In other words, the current coding unit inherits the transform partitioning mode of the adjacent coding unit and a transform combination corresponding to the transform partitioning mode. In still another implementation, when the transform information of the adjacent coding unit includes the transform combination, the transform combination of the adjacent coding unit may be determined as the transform combination of the current coding unit. In other words, the current coding unit may inherit the transform combination of the adjacent coding unit.

Both encoding and decoding parties may agree on determining the transform information of the adjacent coding unit as the transform information of the current coding unit. Alternatively, in some implementations, a series of control methods may be used to control whether a transform inheritance mode is enabled for the current coding unit, thereby determining the transform information of the adjacent coding unit as the transform information of the current coding unit. In this implementation, the encoding device may detect whether the transform inheritance mode is enabled for the current coding unit, and if it is determined that the transform inheritance mode is enabled for the current coding unit, the transform information of the adjacent coding unit is determined as the transform information of the current coding unit. A control method for enabling the transform inheritance mode may include at least one of the following:
(1) Set a transform inheritance mode flag in the video bitstream, and control, by using the transform inheritance mode flag, whether the transform inheritance mode is enabled for the current coding unit. When the transform inheritance mode is enabled for the current coding unit, the transform inheritance mode flag may be set to a first preset value (for example, 1); and when the transform inheritance mode is disabled for the current coding unit, the transform inheritance mode flag is set to a second preset value (for example, 0). A setting position of the transform inheritance mode flag in the video bitstream includes at least one of the following:
a. The transform inheritance mode flag is set in a sequence header of the video, and when the transform inheritance mode flag in the sequence header is a first preset value, the transform inheritance mode is instructed to be enabled for all coding units in all video frames of the video; and when the transform inheritance mode flag in the sequence header is a second preset value, the transform inheritance mode is instructed to be disabled for all the coding units in all the video frames of the video.
b. The transform inheritance mode flag is set in a frame header of the current frame of the video, and when the transform inheritance mode flag in the frame header of the current frame is a first preset value, the transform inheritance mode is instructed to be enabled for all coding units in the current frame; and when the transform inheritance mode flag in the frame header of the current frame is a second preset value, the transform inheritance mode is instructed to be disabled for all the coding units in the current frame.
c. The transform inheritance mode flag is set in a strip header of a strip in which the current coding unit is located, and when the transform inheritance mode flag in the strip header is a first preset value, the transform inheritance mode is instructed to be enabled for all coding units in the strip header; and when the transform inheritance mode flag in the strip header is a second preset value, the transform inheritance mode is instructed to be disabled for all the coding units in the strip header.
d. The transform inheritance mode flag is set in a coding tree unit in which the current coding unit is located, and when the transform inheritance mode flag in the coding tree unit is a first preset value, the transform inheritance mode is instructed to be enabled for all coding units in the coding tree unit; and when the transform inheritance mode flag in the coding tree unit is a second preset value, the transform inheritance mode is instructed to be disabled for all the coding units in the coding tree unit.
e. The transform inheritance mode flag is set in the current coding unit, and when the transform inheritance mode flag in the current coding unit is a first preset value, the transform inheritance mode is instructed to be enabled for all coding units in the current coding unit; and when the transform inheritance mode flag in the current coding unit is a second preset value, the transform inheritance mode is instructed to be disabled for all the coding units in the current coding unit.
(2) Set an enabling condition of the transform inheritance mode, and instruct to enable the transform inheritance mode for the current coding unit when the current coding unit satisfies the enabling condition; and instruct to disable the transform inheritance mode for the current coding unit when the current coding unit does not satisfy the enabling condition, the enabling condition includes a size condition and/or a prediction condition.
f. The enabling condition includes a size condition, the size condition is configured for defining a preset width threshold or a preset height threshold for enabling a transform inheritance mode; and that the current coding unit satisfies the enabling condition includes any one of the following:
\textcircled{1} when the size condition defines the preset width threshold, a width of the current coding unit is greater than the preset width threshold;
\textcircled{2} when the size condition defines the preset height threshold, a height of the current coding unit is greater than the preset height threshold;
\textcircled{3} when the size condition defines the preset width threshold, the width of the current coding unit is less than the preset width threshold; and
\textcircled{4} when the size condition defines the preset height threshold, the height of the current coding unit is less than the preset height threshold.
g. The enabling condition includes a prediction condition; and that the current coding unit satisfies the enabling condition includes: the adjacent coding unit is a prediction reference coding unit of the current coding unit.

A quantity of adjacent coding units may be greater than or equal to 1. When the quantity of adjacent coding units is greater than 1, the encoding device determines, according to the encoding information of the adjacent coding units, that the transform information of the current coding unit may include s31 to s33:

s31: Perform deduplication on the adjacent coding units, to obtain N adjacent coding units, k being a positive integer. For a specific implementation of operation s31, refer to the specific implementation of operation s11, and details are not described herein again.

s32: Determine a target adjacent coding unit in the N adjacent coding units.

A mode in determining the target adjacent coding unit includes at least one of the following: \textcircled{1} Determine the target adjacent coding unit in the N adjacent coding units according to a rate-distortion optimization rule. Specifically, the current coding unit may be encoded based on transform information of each of the N adjacent coding units, a corresponding rate-distortion cost is determined based on a coding result corresponding to each adjacent coding unit, and an adjacent coding unit corresponding to a smallest rate-distortion cost is determined as the target adjacent coding unit. \textcircled{2} A prediction reference coding unit selected by a prediction mode of the current coding unit is selected as the target adjacent coding unit if the N adjacent coding units include at least one prediction reference coding unit of the current coding unit and the prediction mode of the current coding unit is coupled to the transform inheritance mode. The prediction mode includes at least one of the following: an inter merge mode, an intra block copy merge mode, an intra template matching merge mode, and an intra prediction mode. For a specific implementation of selecting the prediction reference coding unit selected by using the prediction mode of the current coding unit as the target adjacent coding unit, refer to the descriptions in the foregoing corresponding part, and details are not described herein again.

s33: Determine transform information of the target adjacent coding unit as the transform information of the current coding unit.
2) The encoding information of the adjacent coding unit includes a residual or a transform coefficient of the adjacent coding unit. In this embodiment of this application, a residual position mode when the current coding unit uses the SBT may be deduced by using the residual or the transform coefficient of the adjacent coding unit. The residual position mode is configured for indicating a sub-block region in which transform encoding residual is performed. The residual position mode when the current coding unit uses the SBT may be quickly deduced by using the residual or the transform coefficient of the adjacent coding unit, thereby improving the encoding efficiency in the encoding process.

The transform information of the current coding unit includes a residual position mode of the current coding unit in the SBT, and the determining transform information of the current coding unit according to encoding information of the adjacent coding unit includes operations s41 to s43:

s41: Reorder each candidate residual position mode in the SBT according to the encoding information of the adjacent coding unit, to obtain a reordering list.

In an implementation, the reordering each candidate residual position mode in the SBT according to the encoding information of the adjacent coding unit, to obtain a reordering list includes: obtaining index information of each candidate residual position mode in the SBT according to the encoding information of the adjacent coding unit; and reordering each candidate residual position mode in the SBT according to a descending order of the index information, to obtain the reordering list. The reordering list includes candidate residual position modes arranged in order and respective index information corresponding to the candidate residual position modes.

Each candidate residual position mode in the SBT separately corresponds to a sub-block transform region at a different position, and the obtaining index information of each candidate residual position mode in the SBT according to the encoding information of the adjacent coding unit includes: \textcircled{1} obtaining a first adjacent coding unit and a second adjacent coding unit of the current coding unit, the first adjacent coding unit being an adjacent coding unit located in a first direction of the current coding unit, and the second adjacent coding unit being an adjacent coding unit located in a second direction of the current coding unit; \textcircled{2} obtaining a first quantity ratio of the first adjacent coding unit, the first quantity ratio being a ratio of a quantity of non-zero residual basic units included in the first adjacent coding unit to a total quantity of all residual basic units in the first adjacent coding unit, obtaining a second quantity ratio of the second adjacent coding unit, and the second quantity ratio being a ratio of a quantity of non-zero residual basic units included in the second adjacent coding unit to a total quantity of all residual basic units in the second adjacent coding unit; and \textcircled{3} allocating the index information to each candidate residual position mode in the SBT according to a magnitude relationship between the first quantity ratio and the second quantity ratio, if the first quantity ratio is greater than or equal to the second quantity ratio, index information allocated to a candidate residual position mode whose sub-block transform region is located in the first direction being greater than index information allocated to a candidate residual position mode whose sub-block transform region is located in the second direction, and if the first quantity ratio is less than the second quantity ratio, the index information allocated to the candidate residual position mode whose sub-block transform region is located in the second direction being greater than the index information allocated to the candidate residual position mode whose sub-block transform region is located in the first direction.

The candidate residual position mode to which the higher index information is allocated is considered to have a correlation with the residual position mode of the current coding unit in the SBT. Therefore, the larger the index information of the residual position mode, the shorter the code length of the candidate residual position mode. A shorter code length of the residual position mode indicates a higher probability that the candidate residual position mode is selected as the residual position mode of the current coding unit in the SBT. For a specific implementation of obtaining index information of each candidate residual position mode in the SBT according to the encoding information of the adjacent coding unit, refer to descriptions in the foregoing corresponding part, and details are not described herein again.

s42: Select a residual position mode of the current coding unit in the SBT from the reordering list.

The selecting a residual position mode of the current coding unit in the SBT from the reordering list may include any one of the following modes: \textcircled{1} In this embodiment of this application, a candidate residual position mode closer to the front in the reordering list indicates a higher probability that the candidate residual position mode is selected. Therefore, a candidate residual position mode with maximum index information (that is, a candidate residual position mode with a shortest code length or a candidate residual position mode with a highest probability of being selected) may be selected from the reordering list as the residual position mode of the current coding unit in the SBT. For example, the candidate residual position modes in the reordering list sequentially arranged include a residual position mode a and a residual position mode b. The residual position mode a is the first in the reordering list. Therefore, the residual position mode a has a highest probability of being selected. In this case, the residual position mode a may be determined as the residual position mode of the current coding unit in the SBT. The residual position mode of the current coding unit in the SBT is selected according to the probability that the candidate residual position mode is selected, so that the residual position mode of the current coding unit in the SBT may be quickly determined, thereby improving encoding efficiency.
\textcircled{2} Determine the residual position mode of the current coding unit in the SBT from the reordering list according to the RDO rule. The encoding device may sequentially determine a rate-distortion cost corresponding to each candidate residual position mode of the current coding unit in the SBT, and use a candidate residual position mode corresponding to a smallest rate-distortion cost as the residual position mode of the current coding unit in the SBT. For example, the candidate residual position modes in the reordering list sequentially arranged include a residual position mode a, a residual position mode b, and a residual position mode c. A rate-distortion cost corresponding to the residual position mode a is less than a rate-distortion cost of the residual position mode b, and the rate-distortion cost of the residual position mode b is less than a rate-distortion cost of the residual position mode c. Therefore, the residual position mode a is determined as the residual position mode of the current coding unit in the SBT.

S904: Encode the current coding unit based on the determined transform information of the current coding unit, to obtain a video bitstream.

Specific implementations of operation S904 may include the following several modes:
(1) The transform information includes the transform partitioning mode and/or the transform combination, and the encoding the current coding unit based on the determined transform information of the current coding unit, to obtain a video bitstream includes: performing transform processing on the current coding unit based on the transform information of the current coding unit, to obtain a transform coefficient of the current coding unit, and performing operations such as quantization and entropy encoding on the transform coefficient of the current coding unit, to obtain the video bitstream.
(2) The encoding information of the adjacent coding unit includes a residual and a transform coefficient of the adjacent coding unit. The transform information of the current coding unit includes a position residual mode flag of the current coding unit in the SBT; and the encoding the current coding unit based on the determined transform information of the current coding unit, to obtain a video bitstream includes: deducing one or more pieces of context index information according to the encoding information of the adjacent coding unit, each piece of context index information corresponding to an entropy encoding mode, for example, the entropy encoding mode includes but is not limited to: a variable length coding, a Huffman coding, and the like; determining, by the encoding device, an entropy encoding mode according to the deduced context index information, and performing entropy encoding on a residual position mode flag of the current coding unit in the SBT according to the determined entropy encoding mode, to obtain the video bitstream. The residual position mode flag is configured for indicating the residual position mode of the current coding unit in the SBT.

The deducing one or more pieces of context index information according to the encoding information of the adjacent coding unit includes: obtaining a first adjacent coding unit and a second adjacent coding unit of the current coding unit, the first adjacent coding unit being an adjacent coding unit located in a first direction of the current coding unit, and the second adjacent coding unit being an adjacent coding unit located in a second direction of the current coding unit; obtaining a first quantity ratio of the first adjacent coding unit, and the first quantity ratio being a ratio of a quantity of non-zero residual basic units included in the first adjacent coding unit to a total quantity of all residual basic units in the first adjacent coding unit; obtaining a second quantity ratio of the second adjacent coding unit, and the second quantity ratio being a ratio of a quantity of non-zero residual basic units included in the second adjacent coding unit to a total quantity of all residual basic units in the second adjacent coding unit; and determining the context index information according to a magnitude relationship between the first quantity ratio and the second quantity ratio, if the first quantity ratio is greater than the second quantity ratio, the context index information being first index information, if the first quantity ratio is equal to the second quantity ratio, the context index information being second index information, and if the first quantity ratio is less than the second quantity ratio, the context index information being third index information. For the deducing one or more pieces of context index information according to the encoding information of the adjacent coding unit herein, refer to the foregoing embodiment of the corresponding part, and details are not described herein again.
(3) The encoding information of the adjacent coding unit includes a residual and a transform coefficient of the adjacent coding unit. The reordering list includes candidate residual position modes arranged in order and respective index information corresponding to the candidate residual position modes. The encoding the current coding unit based on the determined transform information of the current coding unit, to obtain a video bitstream includes: determining index information of the selected residual position mode in the reordering list, and performing entropy encoding on the index information of the selected residual position mode in the reordering list, to obtain the video bitstream.

In this embodiment of this application, greater index information of the candidate residual position mode indicates a shorter code length of the candidate residual position mode, and a shorter code length of the candidate residual position mode indicates a higher probability that the candidate residual position mode is selected. For example, if the index information of the selected residual position mode in the reordering list is largest, when entropy encoding is performed on the selected residual position mode, the selected residual position mode may be encoded by using a relatively short code length. For example, the selected residual position mode is encoded as 0 (that is, 1 bit). In this mode, encoding efficiency can be improved.

In this embodiment of this application, in a video encoding process, the transform information of the current coding unit may be determined based on the encoding information of the adjacent coding unit. In this way, encoding costs consumed for encoding the transform information of the current coding unit can be reduced, thereby reducing bit rate consumption in an entire encoding and decoding process, and further improving encoding efficiency.

FIG. 10 is a schematic structural diagram of a video decoding apparatus according to an embodiment of this application. The video decoding apparatus may be a computer program (including program code) in a computer device. For example, the video decoding apparatus may be application software in the computer device. The video decoding apparatus may be configured to perform some or all operations in the method embodiment shown in FIG. 5. Referring to FIG. 10, the video decoding apparatus includes the following units:
a processing unit 1001, configured to determine a current coding unit in a video bitstream,
the processing unit 1001 being further configured to determine an adjacent coding unit of the current coding unit, and
the processing unit 1001 being further configured to determine transform information of the current coding unit according to encoding information of the adjacent coding unit; and
a decoding unit 1002, configured to decode the current coding unit based on the determined transform information of the current coding unit.

The video decoding apparatus in this embodiment may perform the implementations provided by the operations in FIG. 6. For details, refer to the implementations provided by the operations, and details are not described herein again.

In this embodiment of this application, in a video decoding process, the transform information of the current coding unit may be determined based on the encoding information of the adjacent coding unit. In this way, encoding costs consumed for encoding the transform information of the current coding unit can be reduced, thereby reducing bit rate consumption in an entire encoding and decoding process, and further improving decoding efficiency.

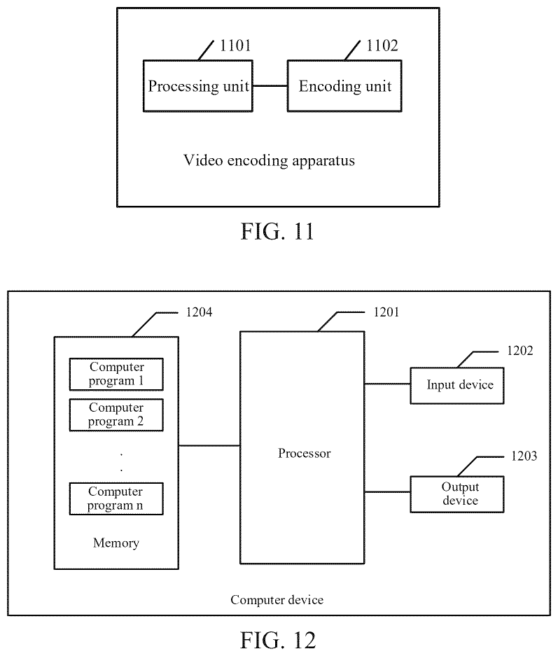

FIG. 11 is a schematic structural diagram of a video encoding apparatus according to an embodiment of this application. The video encoding apparatus may be a computer program (including program code) in a computer device. For example, the video encoding apparatus may be application software in the computer device. The video encoding apparatus may be configured to perform some or all operations in the method embodiment shown in FIG. 9. Referring to FIG. 11, the video encoding apparatus includes the following units:
a processing unit 1101, configured to determine a current coding unit in a video,
the processing unit 1101 being further configured to determine an adjacent coding unit of the current coding unit, and
the processing unit 1101 being further configured to determine transform information of the current coding unit according to encoding information of the adjacent coding unit; and
an encoding unit 1102, configured to encode the current coding unit based on the determined transform information of the current coding unit, to obtain a video bitstream.

The video encoding apparatus in this embodiment may perform the implementations provided by the operations in FIG. 9. For details, refer to the implementations provided by the operations, and details are not described herein again.

In this embodiment of this application, in a video encoding process, the transform information of the current coding unit is directly determined based on the encoding information of the adjacent coding unit. In this way, encoding costs consumed for encoding the transform information of the coding unit can be reduced, thereby reducing bit rate consumption in an entire encoding and decoding process, and further improving encoding efficiency.

Further, an embodiment of this application further provides a schematic structural diagram of a computer device. For the schematic structural diagram of the computer device, refer to FIG. 12. The computer device may include: a processor 1201, an input device 1202, an output device 1203, and a memory 1204. The processor 1201, the input device 1202, the output device 1203, and the memory 1204 are connected by using a bus. The memory 1204 is configured to store a computer program. The computer program includes program instructions. The processor 1201 is configured to execute the program instructions stored in the memory 1204.

In an embodiment, the computer device may be the foregoing decoding device. In this embodiment, the processor 1201 performs the following operations by running the program instructions in the memory 1204:
determining a current coding unit in a video bitstream, and determining an adjacent coding unit of the current coding unit;
determining transform information of the current coding unit according to encoding information of the adjacent coding unit; and
decoding the current coding unit based on the determined transform information of the current coding unit.

The computer device (the decoding device) in this embodiment may perform the implementations provided by the operations in FIG. 6. For details, refer to the implementations provided by the operations, and details are not described herein again.

In this embodiment of this application, in a video decoding process, the transform information of the current coding unit may be determined based on the encoding information of the adjacent coding unit. In this way, encoding costs consumed for encoding the transform information of the current coding unit can be reduced, thereby reducing bit rate consumption in an entire encoding and decoding process, and further improving decoding efficiency.

In another embodiment, the computer device may be the foregoing encoding device. In this embodiment, the processor 1201 performs the following operations by running the program instructions in the memory 1204:
determining a current coding unit in a video, and determining an adjacent coding unit of the current coding unit;
determining transform information of the current coding unit according to encoding information of the adjacent coding unit; and
encoding the current coding unit based on the determined transform information of the current coding unit, to obtain a video bitstream.

The computer device (the encoding device) in this embodiment may perform the implementations provided by the operations in FIG. 9. For details, refer to the implementations provided by the operations, and details are not described herein again.

In this embodiment of this application, in a video coding process, transform information of a current coding unit may be determined based on encoding information of an adjacent coding unit. In this way, costs of encoding the transform information of the coding unit only need to be reduced at an encoder side, thereby reducing bit rate consumption in an entire coding and decoding process, and further improving encoding efficiency.

In addition, an embodiment of this application further provides a non-transitory computer-readable storage medium. The computer-readable storage medium has a computer program stored therein. The computer program includes program instructions. When executing the foregoing program instructions, a processor can perform the methods in the embodiments corresponding to FIG. 6 and FIG. 9. Therefore, details are not described herein again. For technical details not disclosed in the embodiment of the computer-readable storage medium involved in this application, refer to the descriptions of the method embodiments of this application. For example, the program instructions may be deployed on one computer device, or executed on a plurality of computer devices located at one place, or executed on a plurality of computer devices distributed at a plurality of places and interconnected by using a communication network. Alternatively, the computer-readable storage medium has a video bitstream stored therein and the video bitstream is generated by the video decoding method disclosed in the present application.

According to an aspect of this application, a computer program product is provided. The computer program product includes a computer program, and the computer program is stored in a computer-readable storage medium. A processor of a computer device reads the computer program from the computer-readable storage medium, and the processor executes the computer program, so that the computer device may perform the methods in the embodiments corresponding to FIG. 5 and FIG. 9. Therefore, details are not described herein again.

Those of ordinary skill in the art may understand that all or part of the processes of the methods in the foregoing embodiments may be implemented by instructing related hardware via a computer program. The program may be stored in a computer-readable storage medium, and when executed, the program may include the processes in the foregoing method embodiments. The storage medium may be a magnetic disk, an optical disc, a read-only memory (ROM), a random access memory (RAM), or the like.

What is disclosed above is merely preferred embodiments of this application, and certainly is not intended to limit the scope of the claims of this application. Therefore, equivalent variations made in accordance with the claims of this application shall fall within the scope of this application.

What is claimed is:

1. A video decoding method, comprising:
determining a current coding unit in a video bitstream, and an adjacent coding unit of the current coding unit;
determining transform information of the current coding unit according to encoding information of the adjacent coding unit; and
decoding the current coding unit based on the determined transform information of the current coding unit.

2. The method according to claim 1, wherein the adjacent coding unit comprises a temporally adjacent coding unit; and
the temporally adjacent coding unit is a coding unit adjacent to a reference coding unit in a reference frame of the video, the reference frame is any video frame or a specified video frame in the video other than the current frame, and a position of the reference coding unit in the reference frame is the same as a position of the current coding unit in the current frame.

3. The method according to claim 1, wherein the encoding information of the adjacent coding unit comprises transform information of the adjacent coding unit; and the determining transform information of the current coding unit according to encoding information of the adjacent coding unit comprises:
determining the transform information of the adjacent coding unit as the transform information of the current coding unit,
the transform information comprising at least one of a transform partitioning mode or a transform combination, the transform partitioning mode comprising at least one of the following: a residual quad tree mode, a position based transform mode, or a sub-block transform mode, the transform combination comprising a transform kernel of a horizontal transform and a transform kernel of a vertical transform, and the transform kernel comprising at least one of the following: a discrete cosine transform kernel, a discrete sine transform kernel, or transform skip.

4. The method according to claim 1, further comprising:
detecting whether a transform inheritance mode is enabled for the current coding unit; and
performing the operation of determining the transform information of the adjacent coding unit as the transform information of the current coding unit if the transform inheritance mode is enabled for the current coding unit.

5. The method according to claim 1, wherein a control method for enabling the transform inheritance mode comprises at least one of the following:
setting a transform inheritance mode flag in the video bitstream, instructing to enable the transform inheritance mode for the current coding unit when the transform inheritance mode flag is a first preset value, and instructing to disable the transform inheritance mode for the current coding unit when the transform inheritance mode flag is a second preset value; or
setting an enabling condition of the transform inheritance mode, instructing to enable the transform inheritance mode for the current coding unit when the current coding unit satisfies the enabling condition, and instructing to disable the transform inheritance mode for the current coding unit when the current coding unit does not satisfy the enabling condition, the enabling condition comprising at least one of the following: a size condition or a prediction condition.

6. The method according to claim 1, wherein a setting position of the transform inheritance mode flag in the video bitstream comprises at least one of the following:
setting the transform inheritance mode flag in a sequence header of the video, and instructing to enable the transform inheritance mode for all coding units in all video frames of the video when the transform inheritance mode flag in the sequence header is a first preset value; and instructing to disable the transform inheritance mode for all the coding units in all the video frames of the video when the transform inheritance mode flag in the sequence header is a second preset value;
setting the transform inheritance mode flag in a frame header of the current frame of the video, and instructing to enable the transform inheritance mode for all coding units in the current frame when the transform inheritance mode flag in the frame header of the current frame is a first preset value; and instructing to disable the transform inheritance mode for all the coding units in the current frame when the transform inheritance mode flag in the frame header of the current frame is a second preset value;
setting the transform inheritance mode flag in a strip header of a strip in which the current coding unit is located, and instructing to enable the transform inheritance mode for all coding units in the strip header when the transform inheritance mode flag in the strip header is a first preset value; and instructing to disable the transform inheritance mode for all the coding units in the strip header when the transform inheritance mode flag in the strip header is a second preset value;
setting the transform inheritance mode flag in a coding tree unit in which the current coding unit is located, and instructing to enable the transform inheritance mode for all coding units in the coding tree unit when the transform inheritance mode flag in the coding tree unit is a first preset value; and instructing to disable the transform inheritance mode for all the coding units in the coding tree unit when the transform inheritance mode flag in the coding tree unit is a second preset value; or
setting the transform inheritance mode flag in the current coding unit, and instructing to enable the transform inheritance mode for the current coding unit when the transform inheritance mode flag in the current coding unit is a first preset value; and instructing to disable the transform inheritance mode for the current coding unit when the transform inheritance mode flag in the current coding unit is a second preset value.

7. The method according to claim 1, wherein the enabling condition comprises a size condition, and the size condition is configured for defining a preset width threshold or a preset height threshold for enabling the transform inheritance mode; and
that the current coding unit satisfies the enabling condition comprises any one of the following:
when the size condition defines the preset width threshold, a width of the current coding unit is greater than the preset width threshold;
when the size condition defines the preset height threshold, a height of the current coding unit is greater than the preset height threshold;
when the size condition defines the preset width threshold, the width of the current coding unit is less than the preset width threshold; and
when the size condition defines the preset height threshold, the height of the current coding unit is less than the preset height threshold.

8. The method according to claim 1, wherein the enabling condition comprises a prediction condition; and that the current coding unit satisfies the enabling condition comprises: the adjacent coding unit is a prediction reference coding unit of the current coding unit.

9. The method according to claim 1, wherein a quantity of adjacent coding units is greater than 1; and the determining the transform information of the adjacent coding unit as the transform information of the current coding unit comprises:
performing deduplication processing on the adjacent coding units, to obtain N adjacent coding units, k being a positive integer;
determining a target adjacent coding unit in the N adjacent coding units; and
determining transform information of the target adjacent coding unit as the transform information of the current coding unit.

10. The method according to claim 1, wherein a method for determining the target adjacent coding unit comprises:
selecting, if a selecting flag in the video bitstream comprises an identifier of an adjacent coding unit that needs to be inherited, a target adjacent coding unit corresponding to the identifier from the N adjacent coding units according to the selecting flag; or
selecting a prediction reference coding unit selected by a prediction mode of the current coding unit as the target adjacent coding unit if the N adjacent coding units comprise at least one prediction reference coding unit of the current coding unit and the prediction mode of the current coding unit is coupled to the transform inheritance mode,
the prediction mode comprising at least one of the following: an inter merge mode, an intra block copy merge mode, an intra template matching merge mode, and an intra prediction mode.

11. The method according to claim 1, wherein the encoding information of the adjacent coding unit comprises a residual or a transform coefficient of the adjacent coding unit; the video bitstream comprises a position residual mode flag of the current coding unit in the sub-block transform mode; and the determining transform information of the current coding unit according to encoding information of the adjacent coding unit comprises:
deducing one or more pieces of context index information according to the encoding information of the adjacent coding unit, each piece of context index information corresponding to an entropy decoding mode;
determining an entropy decoding mode according to the deduced context index information; and
performing entropy decoding on the residual position mode flag of the current coding unit in the sub-block transform mode according to the determined entropy decoding mode, to obtain a residual position mode of the current coding unit in the sub-block transform mode.

12. The method according to claim 1, wherein the deducing one or more pieces of context index information according to the encoding information of the adjacent coding unit comprises:
obtaining a first adjacent coding unit and a second adjacent coding unit of the current coding unit, the first adjacent coding unit being an adjacent coding unit located in a first direction of the current coding unit, and the second adjacent coding unit being an adjacent coding unit located in a second direction of the current coding unit;
obtaining a first quantity ratio of the first adjacent coding unit, the first quantity ratio being a ratio of a quantity of non-zero residual basic units comprised in the first adjacent coding unit to a total quantity of all residual basic units in the first adjacent coding unit;
obtaining a second quantity ratio of the second adjacent coding unit, the second quantity ratio being a ratio of a quantity of non-zero residual basic units comprised in the second adjacent coding unit to a total quantity of all residual basic units in the second adjacent coding unit; and
determining the context index information according to a magnitude relationship between the first quantity ratio and the second quantity ratio,
if the first quantity ratio is greater than the second quantity ratio, the context index information being first index information; if the first quantity ratio is equal to the second quantity ratio; the context index information being second index information; and if the first quantity ratio is less than the second quantity ratio, the context index information being third index information.

13. The method according to claim 1, wherein the encoding information of the adjacent coding unit comprises a residual or a transform coefficient of the adjacent coding unit; the video bitstream comprises index information of the residual position mode selected for the current coding unit in the sub-block transform mode; and the sub-block transform mode comprises a plurality of candidate residual position modes; and
the determining transform information of the current coding unit according to encoding information of the adjacent coding unit comprises:
reordering each candidate residual position mode in the sub-block transform mode according to the encoding information of the adjacent coding unit, to obtain a reordering list, the reordering list comprising candidate residual position modes arranged in order and respective index information corresponding to the candidate residual position modes;
performing entropy decoding on the video bitstream, to obtain the index information of the residual position mode selected for the current coding unit in the sub-block transform mode; and
determining, from the reordering list according to the index information of the residual position mode selected for the current coding unit in the sub-block transform mode, the residual position mode of the current coding unit in the sub-block transform mode.

14. The method according to claim 1, wherein the reordering each candidate residual position mode in the sub-block transform mode according to the encoding information of the adjacent coding unit, to obtain a reordering list comprises:
obtaining index information of each candidate residual position mode in the sub-block transform mode according to the encoding information of the adjacent coding unit; and
reordering each candidate residual position mode in the sub-block transform mode according to a descending order of the index information, to obtain the reordering list,
greater index information of the candidate residual position mode indicating a shorter code length of the candidate residual position mode, and a shorter code length of the candidate residual position mode indicating a higher probability that the candidate residual position mode is selected.

15. The method according to claim 1, wherein each candidate residual position mode in the sub-block transform mode separately corresponds to sub-block transform regions at different positions; and the obtaining index information of each candidate residual position mode in the sub-block transform mode according to the encoding information of the adjacent coding unit comprises:
obtaining a first adjacent coding unit and a second adjacent coding unit of the current coding unit, the first adjacent coding unit being an adjacent coding unit located in a first direction of the current coding unit, and the second adjacent coding unit being an adjacent coding unit located in a second direction of the current coding unit;
obtaining a first quantity ratio of the first adjacent coding unit, the first quantity ratio being a ratio of a quantity of non-zero residual basic units comprised in the first adjacent coding unit to a total quantity of all residual basic units in the first adjacent coding unit;
obtaining a second quantity ratio of the second adjacent coding unit, the second quantity ratio being a ratio of a quantity of non-zero residual basic units comprised in the second adjacent coding unit to a total quantity of all residual basic units in the second adjacent coding unit; and
allocating index information to each candidate residual position mode in the sub-block transform mode according to a magnitude relationship between the first quantity ratio and the second quantity ratio,
if the first quantity ratio is greater than or equal to the second quantity ratio, index information allocated to a candidate residual position mode whose sub-block transform region is located in the first direction being greater than index information allocated to a candidate residual position mode whose sub-block transform region is located in the second direction, and
if the first quantity ratio is less than the second quantity ratio, the index information allocated to the candidate residual position mode whose sub-block transform region is located in the second direction being greater than the index information allocated to the candidate residual position mode whose sub-block transform region is located in the first direction.

16. A computer device, comprising:
a processor; and
a computer-readable storage medium, having a computer program stored therein, the computer program, when executed by the processor, causing the computer device to perform a video decoding method including:
determining a current coding unit in a video bitstream, and an adjacent coding unit of the current coding unit;
determining transform information of the current coding unit according to encoding information of the adjacent coding unit; and
decoding the current coding unit based on the determined transform information of the current coding unit.

17. The computer device according to claim 16, wherein the adjacent coding unit comprises a temporally adjacent coding unit; and
the temporally adjacent coding unit is a coding unit adjacent to a reference coding unit in a reference frame of the video, the reference frame is any video frame or a specified video frame in the video other than the current frame, and a position of the reference coding unit in the reference frame is the same as a position of the current coding unit in the current frame.

18. The computer device according to claim 16, wherein the encoding information of the adjacent coding unit comprises transform information of the adjacent coding unit; and the determining transform information of the current coding unit according to encoding information of the adjacent coding unit comprises:
determining the transform information of the adjacent coding unit as the transform information of the current coding unit,
the transform information comprising at least one of a transform partitioning mode or a transform combination, the transform partitioning mode comprising at least one of the following: a residual quad tree mode, a position based transform mode, or a sub-block transform mode, the transform combination comprising a transform kernel of a horizontal transform and a transform kernel of a vertical transform, and the transform kernel comprising at least one of the following: a discrete cosine transform kernel, a discrete sine transform kernel, or transform skip.

19. The computer device according to claim 16, wherein the method further comprises:
detecting whether a transform inheritance mode is enabled for the current coding unit; and
performing the operation of determining the transform information of the adjacent coding unit as the transform information of the current coding unit if the transform inheritance mode is enabled for the current coding unit.

20. A non-transitory computer-readable storage medium storing a video bitstream that is generated by a video decoding method, the video decoding method comprising:
determining a current coding unit in a video bitstream, and an adjacent coding unit of the current coding unit;
determining transform information of the current coding unit according to encoding information of the adjacent coding unit; and
decoding the current coding unit based on the determined transform information of the current coding unit.
